(19) United States
(12) Patent Application Publication
(10) Pub. No.: US 2025/0005247 A1
(43) Pub. Date: Jan. 2, 2025

(54) METHOD AND SYSTEM FOR EMULATING IC DESIGN WITH FPGA, AND STORAGE MEDIUM

(71) Applicant: SHANGHAI UNIVISTA INDUSTRIAL SOFTWARE GROUP CO., LTD., SHANGHAI (CN)

(72) Inventors: Jingxuan CHI, SHANGHAI (CN); Jiong CAO, SHANGHAI (CN); Cheng LI, SHANGHAI (CN)

(21) Appl. No.: 18/276,737

(22) PCT Filed: Jul. 25, 2023
(86) PCT No.: PCT/CN2023/109188

§ 371 Date: Aug. 10, 2023

(30) Foreign Application Priority Data
Aug. 24, 2022 (CN) 202211018303.7
Jun. 5, 2023 (CN) 202310658622.2

(51) Int. Cl. G06F 30/347

(52) U.S. Cl. CPC G06F 30/347

(57) ABSTRACT

The invention relates to the technical field of electronic design automation (EDA), especially relates to a method and a system for emulating an IC design with an FPGA, and a storage medium. It is characterized by substituting clock models for the sequential cells; adding a user enable to an external port of a clock model compared to the port of a sequential cell in the IC design, through a user clock to which a user enable of a clock model is connected and a primary clock′ to which a clock input of a clock model is connected, a clock model_{[CA]} reproducing the function of the sequential cell in the IC design by controlling outputting time of a data sample, and the clock model_{[CB]} reproducing the function of the sequential cell in the IC design by controlling data sampling time; and configuring phase shifts for primary clocks' by which the clock model_{[CA]} and the clock model_{[CB]} are driven, so as to solve the technical problem of sampling error due to presence of the user clock while ensuring the functions of the original sequential cells.

### RELATED APPLICATIONS

The application is the U.S. national phase of PCT/CN2023/109188 filed Jul. 25, 2023, which claims the benefit of CN202211018303.7 filed Aug. 24, 2022 and CN202310658622.2 filed Jun. 5, 2023, each of which is incorporated herein by reference in its entirety.

### FIELD OF THE INVENTION

The invention relates to the technical field of electronic design automation (EDA), specially relates to a method and a system for emulating an IC design with an FPGA, and a storage medium.

### BACKGROUND OF THE INVENTION

Integrated circuit design (IC design) is a design flow with IC or super-large-scale IC as target. IC design comprises application specific integrated circuit (ASIC) design, and ASIC is IC designed and manufactured according to requirements of specific users and needs of specific electronic systems. After the IC design is completed, it will enter tape-out stage, the cost of the tape-out is very high, and once there is a problem, it can result in tape-out failure. In order to reduce the risk of tape-out failure, it is necessary to fully validate software and hardware in the IC before tape-out, so as to timely discover some problems that are difficult to find in the design process and timely adjust the design to ensure the smooth progress of the tape-out. Common verification tools include simulation and emulation. Emulation refers to simulating hardware actually used in the chip design by the user and then emulate it. Emulation is mostly based on field programmable gate array (FPGA) chip for design. The FPGA chip comprises components such as lookup table (LUT) and register, and different functions can be realized by configuring electrical signals of corresponding components through software.

Because the physical structures of IC and FPGA are different, IC design is based on a standard cell library, and FPGA is based on a macro-cell module (lookup table) provided by a manufacturer, if you want to verify the IC design with the FPGA, a certain conversion must be made on the IC design to transplant it on the FPGA. The biggest difference between the cores of an IC and an FPGA chip is a clock structure. The clock structure in an IC includes at least one clock tree, and each clock tree has a clock tree structure composed of a primary clock and a plurality of generated clocks. In an IC design before wiring design, due to circuit delay, glitches are present in the generated clocks generated by combinatorial logic operations. If the generated clocks with glitches are connected to a clock input of a sequential cell, because the clock input of the sequential cell is sensitive to glitches, the sequential cell is mistakenly triggered to sample signals from the data input, resulting in error of the data sample output by a data output of the sequential cell. In order to solve the glitch problem, the delay of combination logic input signal can be controlled by strict wiring design in IC design, and then the generation of glitch can be controlled. However, if IC design is directly applied on FPGA, since FPGA is a pre-wired semi-custom circuit, the generation of glitches cannot be controlled in the manner of controlling delay by controlling wiring length, and the problem of glitch-caused error data sample output by the sequential cell cannot be avoided.

### OBJECTS AND SUMMARY OF THE INVENTION

It is an object of the claimed invention to overcome some or all of these shortcomings.

For this, according to the first aspect, the present invention provides a method for emulating an IC design with an FPGA, comprising the steps of:
S1) identifying in the IC design: a primary clock, a subcircuit, a plurality of generated clocks and a plurality of sequential cells, wherein the plurality of generated clocks are derived from the primary clock after being processed by the subcircuit, and a user clock being connected to one of the plurality of sequential cells is the primary clock or one of the plurality of generated clocks.
S2) converting the IC design into a directed graph, including: 2.1) converting the plurality of sequential cells to a plurality of nodes, and 2.2) constructing the directed graph by connecting the plurality of nodes.

Wherein, S2.1 includes converting a sequential cell in the plurality of sequential cells to a node, including: i) identifying on the sequential cell: a user clock by which the sequential cell is driven; a data input; a user-clock input and a data output, wherein the user clock is connected to the user-clock input; ii) converting the sequential cell into a node, including: defining a logic path having a pair of endpoints, wherein: the user-clock input constitutes one of the pair of endpoints; and the data output constitutes the other one of the pair of endpoints; defining a node on the logic path between the pair of endpoints; and defining another logic path and defining a node on the other logic path between its pair of endpoints.
S3), configuring the plurality of nodes on the directed graph which includes exactly a root node and a plurality of leaf nodes, including: 3.1) inserting a clock model at a node on the directed graph, and 3.2) configuring a phase shift for a primary clock′.

Wherein, S3.1 includes 3.1.1) labeling on the directed graph at least a node as group A and at least another node as group B; 3.1.2) modifying the nodes that are labeled as group A; and 3.1.3) modifying the nodes that are labeled as group B.

Further, S3.1.2 includes i) configuring the clock model_{[CA]}, which includes a data input_{[CA]}, a data output_{[CA]}, a user enable_{[CA]} and a clock input_{[CA]}.
ii) modifying a node_{[A]} in the plurality of nodes being labeled as group A, including:
ii.1) identifying a logic path by which the node_{[A]} is defined in view of S2, wherein: an endpoint of the logic path is located at a user-clock input_{[A]}; the other endpoint of the logic path is located at a data output_{[A]}; and the user clock_{[A]} is connected to the user-clock input_{[A]}; ii.2) inserting a clock model_{[CA]} at the node_{[A]}, including: connecting the data input_{[CA]} to what was connected to the data input_{[A]}; connecting the data output_{[CA]} to what was connected to the data output_{[A]}; connecting the user enable_{[CA]} to what was connected to the user-clock input_{[A]}; and connecting the clock input_{[CA]} to a primary clock′ which is equal to or greater than the primary clock in frequencies; and ii.3) configuring the clock model_{[CA]}, including: sampling a signal from the data input_{[CA]} at an active edge of the primary clock′ to obtain a data sample for a period of the primary clock′ led by the active edge; when an N-th active edge is occurring on the user clock_{[A]}: obtaining a data sample_{[N]} for a contemporary period of the primary clock′; and outputting to the data output_{[CA]} the data sample_{[N]} until an N+1-th active edge occurs on the user clock_{[A]}; and when the N+1-th active edge is occurring on the user clock_{[A]}: obtaining a data sample_{[N+1]} for a contemporary period of the primary clock′; and outputting to the data output_{[CA]} the data sample_{[N+1]} until an N+2-th active edge occurs on the user clock_{[A]}.
iii) modifying the rest of nodes_{[A]} in the plurality of nodes being labeled as group A.

### Further, S3.1.3 Includes:

i) configuring the clock model_{[CB]}, which includes a data input_{[CB]}, a data output_{[CB]}, a user enable_{[CB]} and a clock input_{[CB]}.
ii) modifying a node_{[B]} in the plurality of nodes being labeled as group B, including: ii.1) identifying a logic path by which the node_{[B]} is defined in view of S2, wherein: an endpoint of the logic path is located at a user-clock input_{[B]}; the other endpoint of the logic path is located at a data output_{[B]}; and the user clock_{[B]} is connected to the user-clock input_{[B]}; ii.2) inserting the clock model_{[CB]} at the node_{[B]}, including: connecting the data input_{[CB]} to what was connected to the data input_{[B]}; connecting the data output_{[CB]} to what was connected to the data output_{[B]}; connecting the user enable_{[CB]} to what was connected to the user-clock input_{[B]}; and connecting the clock input_{[CB]} to a primary clock′ which is equal to or greater than the primary clock in frequencies; and ii.3) configuring the clock model_{[CB]}, including: when an active edge is occurring on the user clock_{[B]} and when an active edge is occurring on the primary clock′: sampling a signal from the data input_{[CB]} to obtain a data sample for a period of the primary clock′ led by the active edge; and; and when no active edge occurs on the user clock_{[B]} or no active edge occurs on the primary clock′: sampling nothing from the data input_{[CB]}; and outputting nothing to the data output_{[CB]}.
iii) modifying the rest of nodes_{[B]} in the plurality of nodes being labeled as group B.
Wherein, S3.2 includes: 3.2.1) identifying a path on the directed graph and configuring a phase shift for the primary clock′ to which a node on the path is connected; 3.2.2) numbering a total of K nodes on the path, wherein a node_{[#1]} is the root node and a node_{[#K]} is one of the leaf nodes; and 3.2.3) identifying another path on the directed graph and configuring a phase shift for a primary clock′ to which a node on the other path is connected.

Wherein, S3.2.2 includes i) configuring a phase shift for the primary clock′ to which a node being labeled as group B is connected, including: i.1) identifying on the path a set of nodes that are labeled as group B, which includes a node_{[#M]} and a node_{[#N]}; and i.2) letting F(x−t_{M})=F(x−t_{N}), wherein: t_{M}>t_{N}; 1≤N<M≤K; F(x−t_{M}) represents a waveform of the primary clock′ to which the node_{[#M]} is connected; t_{M} is a phase shift; F(x−t_{N}) represents a waveform of the primary clock′ to which the node_{[#N]} is connected; and ty is a phase shift; ii) configuring a phase shift for the primary clock′ to which a node being labeled as group A is connected, including: ii.1) identifying on the path a set of nodes that are labeled as group A, which includes a node_{[#U]}; ii.2) when 1<U<K: identifying a nearest set of nodes to the node_{[#U]} that are labeled as group B, which includes a node_{[#R]} and a node_{[#S]}, wherein: R<U<S; and letting exactly one of the two propositions be true: F(x−t_{U})=F(x−t_{R}), wherein t_{U}≥t_{R}; and F(x−t_{U})=F(x−t_{S}), wherein t_{S}≥t_{U}; ii.3) when U=1: identifying a nearest set of nodes to the node_{[#1]} that are labeled as group B, which includes a node_{[#S]}; and letting F(x−t_{U})=F(x−t_{S}), wherein t_{S}≥t_{U}; and ii.4) when U=K: identifying a nearest set of nodes to the node_{[#K]} that are labeled as group B, which includes node_{[#R]}; and letting F(x−t_{U})=F(x−t_{R}), wherein t_{U}≥t_{R}, wherein: F(x−t_{R}) represents a waveform of the primary clock′ to which the node_{[#R]} is connected; t_{R} indicates the waveform's phase; F(x−t_{U}) represents a waveform of the primary clock′ to which the node_{[#U]} is connected; t_{U} indicates the waveform's phase; F(x−t_{S}) represents a waveform of the primary clock′ to which the node_{[#S]} is connected; and t_{S} indicates the waveform's phase.

The second aspect, the present invention provides a system for emulating an IC design with an FPGA, comprising a processor and a computer-readable storage medium in communication with the processor, wherein: the system implements the method in claim 1 when the processor executes a program in the computer-readable storage medium.

The third aspect, the present invention provides a non-transitory computer-readable storage medium in which at least one instruction or at least one program is stored, wherein: the at least one instruction or the at least one program is loadable and executable by a processor to implement the method for emulating an IC design with an FPGA.

The present invention has at least the following beneficial effects:

The present invention provides a method for emulating an IC design with an FPGA, comprising the steps of: extracting a directed graph by identifying logic paths of the sequential cells in an IC design, and substituting clock models for the sequential cells corresponding to nodes in the directed graph; adding a user enable to an external port of a clock model compared to the port of a sequential cell in the IC design, through a user clock to which a user enable of a clock model is connected and a primary clock′ to which a clock input of a clock model is connected, a clock model_{[CA]} reproducing the function of the sequential cell in the IC design by controlling outputting time of a data sample, and the clock model_{[CB]} reproducing the function of the sequential cell in the IC design by controlling data sampling time; and configuring phase shifts for primary clocks' by which the clock model_{[CA]} and the clock model_{[CB]} are driven to ensure normal operation of a circuit. The primary clocks' are directly connected to the clock inputs of the clock model_{[CA]} and the clock model_{[CB]} and contain no glitch, the user clock is connected to user enables of the clock model_{[CA]} and the clock model_{[CB]}, but the user enable is non-sensitive to glitch-containing user clock, so that the invention can solve the technical problem of sampling error due to presence of the user clock while ensuring the functions of the original sequential cells.

### BRIEF DESCRIPTION OF FIGURES

Other advantages, objectives and features of the present invention are in non-limiting description in at least one specific example for describing a method and a system for emulating an IC design with an FPGA and a storage medium and according to the figures, wherein:

FIG. 1 a structure schematic drawing of a clock model_{[A]} provided by an example in the prevent invention;

FIG. 2 is a structure schematic drawing of a clock model_{[CB]} provided by an example in the prevent invention;

FIG. 3 is comparison diagram of a sequential cell before and after being to what a clock model is substituted for;

FIG. 4 is timing sequence schematic drawing of clock model_{[CB]} before the primary clock′ shifts;

FIG. 5 is timing sequence comparison schematic drawing of clock model_{[CB]} before and after the primary clock′ shifts;

FIG. 6 is comparison schematic drawing of ideal condition in prior art to actually generated glitches;

FIG. 7 is a flow diagram of a method for emulating an IC design based on FPGA provided by an example of the present invention;

FIG. 8 is flow diagram of S2 provided by an example of the present invention;

FIG. 9 is flow diagram of S3 provided by an example of the present invention;

FIG. 10 is a structure schematic drawing of a clock tree;

FIG. 11 is a directed graph obtained by extracting FIG. 10;

FIG. 12 is a schematic drawing of a sequential cell for which a clock model_{[CA]} is substituted;

FIG. 13 is a structure schematic drawing of a clock model_{[CA]} provided by another example in the prevent invention;

FIG. 14 is a structure schematic drawing of a clock model_{[CB]} provided by another one example in the prevent invention;

FIG. 15 is a structure schematic drawing of a clock model_{[CB]} provided by another one example in the prevent invention;

FIG. 16 is a structure schematic drawing of a clock model_{[CB]} provided by an other example in the prevent invention;

FIG. 17 is a structure schematic drawing of a sequential cell after being substituted with a clock model;

FIG. 18 is a structure schematic drawing of a clock detector for a clock model_{[CA]} and a clock model_{[CB]} jointly and provided in the present invention;

FIG. 19 is a structure schematic drawing of a clock detector for two clock models_{[CA]} jointly and provided in the present invention;

FIG. 20 is a structure schematic drawing of a clock detector for two clock models_{[CB]} jointly and provided in the present invention;

FIG. 21 is a schematic drawing of a timing sequence between two nodes labeled as group B on a same path;

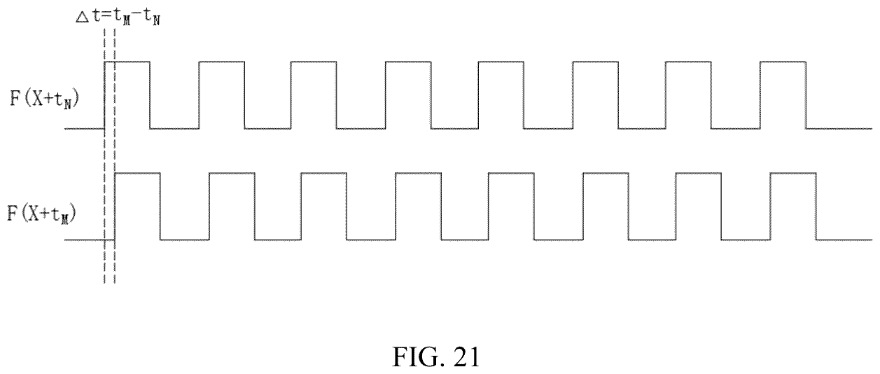

FIG. 22 is a schematic drawing of a timing sequence between a node labeled as group A and a closest node labeled as group B on a same path; and

FIG. 23 is a schematic drawing of another timing sequence between a node labeled as group A and a closest node labeled as group B on a same path.

### DETAILED DESCRIPTION OF THE EMBODIMENTS

In an IC design before wiring design, glitches are present in the generated clocks generated by combinatorial logic operations due to circuit delay.

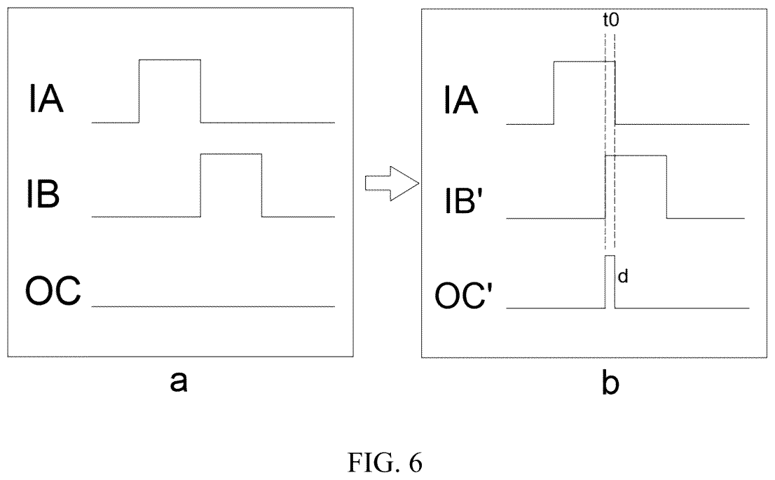

In an IC design before wiring design, glitches are present in the generated clocks generated by combinatorial logic operations due to circuit delay. To better understand where glitches come from, an AND gate circuit with two inputs is adopted for example for description, referring to FIG. 6. In FIG. 6, the two inputs of the AND gate circuit are respectively inputs with a wave signal IA and a wave signal IB, and the wave signal output from the output of the AND gate is OC. However, in the case of delay control without wiring design, due to the delay caused by wiring length or the delay caused by the operation of the previous-level circuit, it cannot guarantee that the signals from the two inputs of the AND gate circuit flip according to a preset time interval. When delays of the waveform signals input by the two inputs of the AND gate circuit are inconsistent, as shown in FIG. 6, and if the delay time of the waveform signal IB′ input by the AND gate circuit is t0 compared to the waveform signal IA, at this time, the waveform signal output by the AND gate circuit is OC′ with d, wherein, compared with the ideal waveform signal OC, it appears d which should not appear in OC′, and d is the glitch. That is to say, due to the delay, the arrival times of a plurality of signals that should be input at the same time have a sequential relationship, forming a competition relationship, and the error output generated by the competition is glitch. If the generated clocks having glitches are connected to a clock input of a sequential cell, because the clock input of the sequential cell is sensitive to glitches, the sequential cell is mistakenly triggered to sample signals from the data input, and it cannot avoid the problem of outputting error data sample from the data output of the sequential cell. In order to solve the glitch problem, the delay of combination logic input signal can be controlled by strict wiring design in IC design, and then the generation of glitches can be controlled. However, if IC design is directly applied on an FPGA, since the FPGA is a pre-wired semi-custom circuit, the generation of glitches cannot be controlled in the manner of controlling delay by controlling wiring length.

In order to solve the problem of sampling error caused by inputting glitch-containing generated clock to a clock input of a sequential cell and realize application of the sequential cell in IC design on FPGA at the same time, sequential cells in an IC design are extracted, and then logic paths in each sequential cell is extracted with the path from a clock input to a data output in a sequential cell as a logic path. A node is defined on the logic path. The flowing direction from a data output of the contemporary node to a clock input of a next node as a directed edge, and a directed graph is obtained by connecting nodes with the edge. The directed graph includes a root node, a plurality of leaf nodes, and a plurality of intermediate nodes between the root node and the plurality of leaf nodes. At least one path is present between the root node and each leaf node. The root node in the directed graph corresponds to the root node in a clock tree. A user clock by which the root node is driven is a primary clock, and the user clocks by which other nodes are driven are generated clocks. Logic paths in all sequential cells of a clock tree in an IC design and the relationship among the logic paths are characterized by all nodes in the directed digraph and the connection relationship among the nodes.

After extracting the directed graph, sequential cells represented by a node of a plurality of nodes in the directed graph as a whole are needed to be substituted with clock models in FPGA with equivalent logic function, including clock models_{[CA]} and clock models_{[CB]}. In order to solve the glitch problem, a new primary clock′ is introduced. The primary clock′ directly is connected to the clock input of the clock model_{[CA]} or the clock model_{[CB]}, there is no combinatorial logic between the primary clock′ and the clock input of the clock model_{[CA]} or the clock input of the clock model_{[CB]}, and no delay is introduced, so that there is no glitch at the clock inputs of the clock model_{[CA]} and the clock model_{[CB]}, solving the glitch problem. The user clock is used as a user enable to be connected to the clock model_{[CA]} or the clock model_{[CB]}, since the user clock of the user enable needs to meet the requirements of setup time and retention time, wherein the setup time refers to the time when the data remains stable until an active edge of primary clock′ arrives, the retention time refers to the time when the data remains stable after the active edge of the primary clock′ arrives, while the glitch has generally short retention time, which cannot meet the requirements of setup time and retention time, and can be shielded, so that the glitch is no longer harmful and will not affect data sampling, and the user enable is non-sensitive to glitch. The clock model_{[CA]} and the clock model_{[CB]} are driven by coordination of the primary clock′ and the user clock for data sampling to ensure function recurrence of the sequential cells in an IC design. The invention provides two types of clock models. The clock model_{[CA]} emulates the function of sequential cells in an IC design by controlling a user clock to drive the clock model_{[CA]} to output a data sample from a data output, and the clock model_{[CB]} emulates the function of sequential cells in an IC design by controlling a user clock to sample and output data at a data input in cooperation with the primary clock′. Finally, an appropriate phase shift is configured to the primary clock′ such that the modified circuit can be in normal operation.

Based on this, the invention provides the following three examples. In the scheme provided in example 1, at least one sequential cell is substituted with a clock model_{[CA]} and at least another sequential cell is substituted with a clock model_{[CB]}. In the scheme provided in example 2, all sequential cells are substituted with clock models_{[CA]}. In the scheme provided in example 3, all sequential cells are substituted with clock models_{[CB]}.

### Example 1

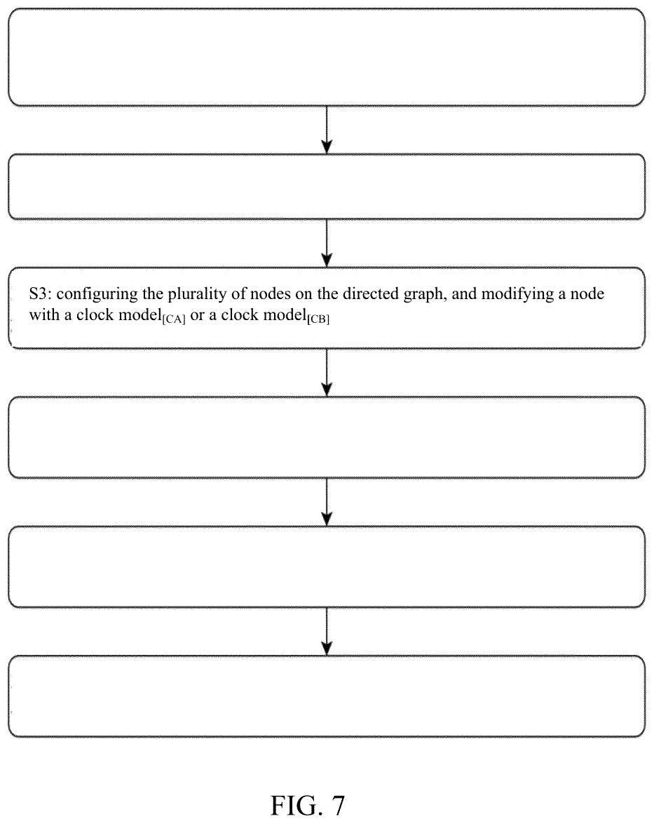

Referring to FIG. 7, a method for emulating an IC design with an FPGA proposed by the present invention is described in detail by combining with FIG. 7. The method comprises the steps of:
S1) identifying in the IC design: a primary clock; a subcircuit; a plurality of generated clocks, which are derived from the primary clock after being processed by the subcircuit; and a plurality of sequential cells, wherein a user clock being connected to one of the plurality of sequential cells is the primary clock or one of the plurality of generated clocks.

Preferably, the primary clock is a clock input source of an IC design, and usually represents a physical clock.

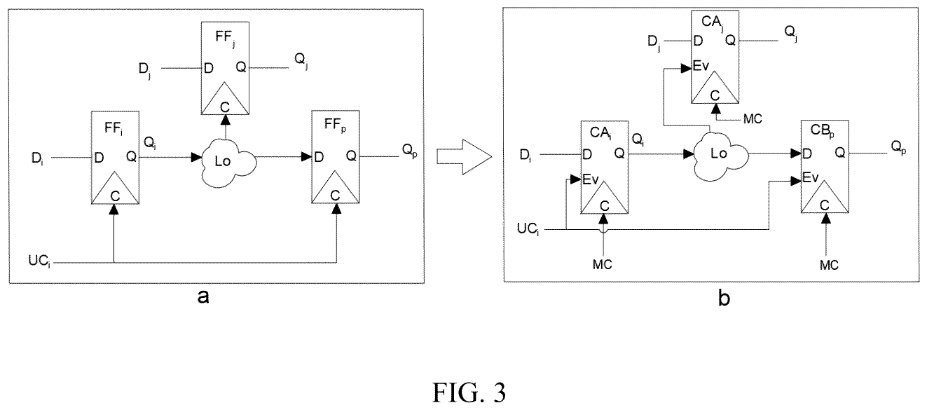

Preferably, the subcircuit is a combinational logic circuit, a sequential logic circuit or hybrid circuit of a combinational logic circuit and a sequential logic circuit. As an example, the subcircuit can be a frequency divider, a gate clock or a multiplexer, wherein the frequency divider is a sequential logic circuit, and the gate clock and the multiplexer are combinational logic circuits.

Wherein, the generated clocks are derived from the primary clock or a previous-level generated clock after being processed by the subcircuit. Different generated clocks are derived from the primary clock by being processed by different subcircuits, and next-level generated clocks can be also derived from the generated clocks after being processed by another subcircuit, and so on, the primary clock and the topologic structure of the generated clocks form a clock tree structure. The generated clocks are used to be connected to the clock inputs of a plurality of sequential cells to drive the sequential cells for data sampling.

Wherein, the sequential cell comprises a user-clock input, a data input and a data output. When an active edge is occurring on a user clock connected to the user-clock input, the sequential cell is triggered to sample data signal from the data input, and data sample is output by the data output. The active edge of the user clock is used as driving signal to drive the sequential cell for sampling. Under the action of the driving signal, the data input to the sequential cell is sampled and output to obtain the generated clocks. The data sample output from the data output of a sequential cell can be used as clock input signal of the clock input of another sequential cell, and can also be used as data input signal of the data input of another sequential cell.

Wherein, the sequential cells are connected by cascade connection or series connection, referring to FIG. 3. in FIG. 3, the part a is possible connection structure among sequential cells in an IC design, wherein, each sequential cell includes a data input_{[D]}, a clock input_{[C]} and a data output_{[Q]}, the cascade connection is that the data signal_{[Qi]} output from the data output_{[Q]} of the i-th sequential cell_{[FFi]} is connected to the clock input_{[C]} of the j-th sequential cell, and the serial connection is that the data signal_{[Qi]} output from the data output_{[Q]} of the i-th sequential cell_{[FFi]} is connected to the data input_{[D]} of the p-th sequential cell.

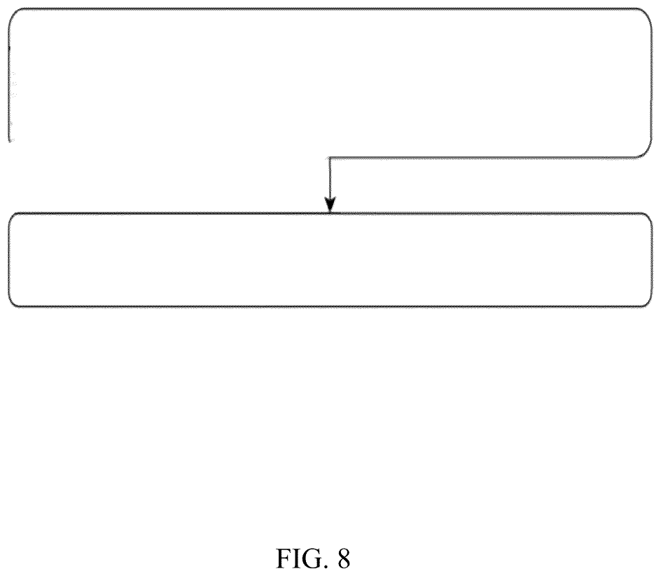

Preferably, the sequential cell is configured to be a latch, a trigger, a register, a shifting register or a memory. Other combined units having the same function in prior art fall within the protection scope of the prevent invention.
S2) converting the IC design into a directed graph. Referring to FIG. 8, S2) includes: 2.1) converting the plurality of sequential cells to a plurality of nodes, and 2.2) constructing the directed graph by connecting the plurality of nodes.

It should be noted that, an IC design includes a combinational logic circuit and a sequential logic circuit. The problem to be solved in the present invention is error data sampling due to glitches present in a clock input signal inputted to a sequential cell. In order to solve the problem, it is necessary to extract sequential cells for processing.

Further, S2.1 further includes: 2.2.1) converting a sequential cell in the plurality of sequential cells to a node, including: i) identifying on the sequential cell: a user clock by which the sequential cell is driven; a data input; a user-clock input and a data output, wherein the user clock is connected to the user-clock input; ii) converting the sequential cell into a node, including: defining a logic path having a pair of endpoints, wherein: the user-clock input constitutes one of the pair of endpoints; and the data output constitutes the other one of the pair of endpoints; defining a node on the logic path between the pair of endpoints; and 2.1.2) converting the rest of the plurality of sequential cells to nodes in view of the step of converting a sequential cell in the plurality of sequential cells to a node. The sequential cells can be extracted into an abstract node in the manner of identifying a logic path to extract the node, and only a topologic relationship among related sequential cells is extracted, so as to avoid interference of other irrelevant structures.

Further, the step for connecting an edge of the nodes in S2.2 includes: connecting the nodes with a directed edge having flowing direction from a data output of a node to a clock input of a next node. A directed graph is obtained by connecting nodes while ignoring the combinatorial logic among the sequential cells.

Preferably, the storage method of the directed graph is an adjacency matrix or an adjacency list.

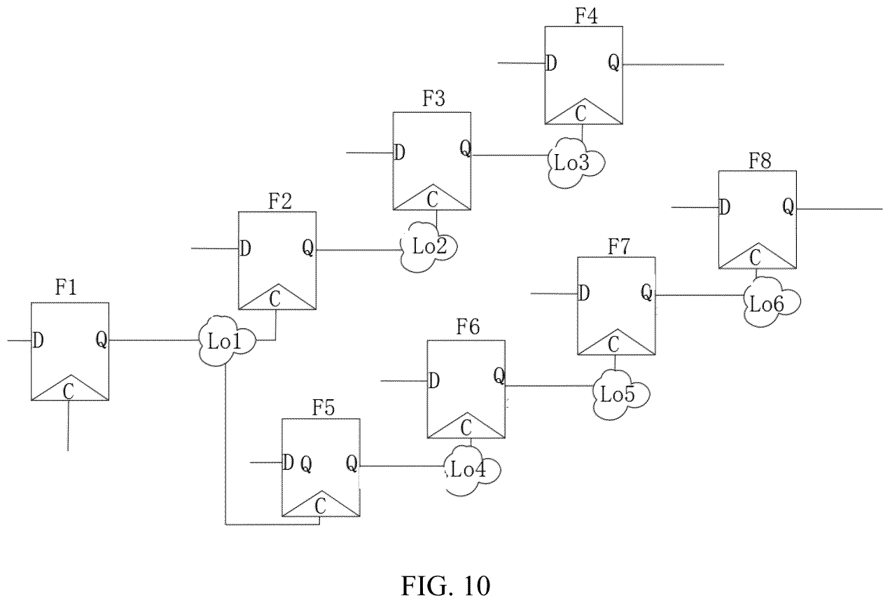

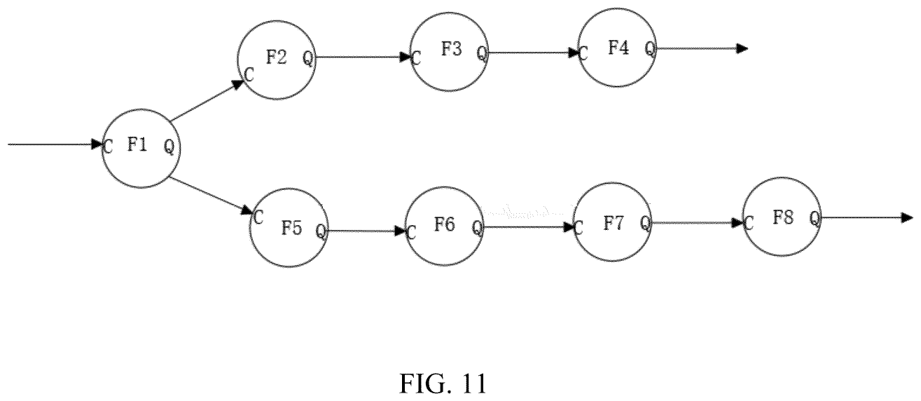

As an example, to better understand the present invention, a clock tree having one part composed of eight sequential cells is adopted for example, referring to FIG. 10 showing partial clock tree structure in an IC design. The clock tree includes sequential cells_{[F1]-[F8]} and combinational logics_{[Lo1]-[Lo6]}. The sequential cells have the same external port, and each sequential cell includes a data input_{[D]}, a user clock input_{[C]} and a data output_{[Q]}. In the clock tree, the sequential cell_{[F1]} is adopted as root node, and the user clock input_{[C]} of the sequential cell_{[F1]} is connected to a primary clock. For a path including sequential cells_{[F2]-[F4]} with the root node as the parent node, the primary clock drives the sequential cell_{[F1]} to sample input data to obtain a generated clock_{[1]}. The generated clock_{[1]} drives the sequential cell_{[F2]} to sample input data through a combination logic [Lo1] to obtain generated clock_{[2]}, and so on to obtain a generated clock_{[3]} and a generated clock_{[4]}. Similarly, generation clocks_{[5]-[8]} can be obtained in another path adopting the root node as parent node and including sequential cells_{[F5]-[F8]}. With a logic path formed from the user clock input_{[C]} to the data output_{[Q]} in each sequential cell as a node and with flowing of data outputted from a data output of a sequential cell to a clock input of next node as a directed edge, the clock tree structure shown in FIG. 10 is extracted to obtain a directed graph. Referring to FIG. 11, it shows the directed graph obtained by extracting the clock tree structure shown in FIG. 10. In FIG. 11, the clock input_{[C]} of the root node is connected to a primary clock. In the directed graph, the user clock inputs [C] of the nodes except the root node are connected to generated clocks. The directed edge in the directed graph is the flow direction of the data output signal. In FIG. 11, each node represents the extracted sequential cell, and the sequential cells and the nodes are in one-to-one mapping relationship.

S3) configuring the nodes on the directed graph, wherein, the directed graph includes exactly a root node and a plurality of leaf nodes. It should be noted that, a user clock connected to a root node is configured to be a primary clock, except the root node, the user clocks connected to other nodes in the directed graph are generated clocks.

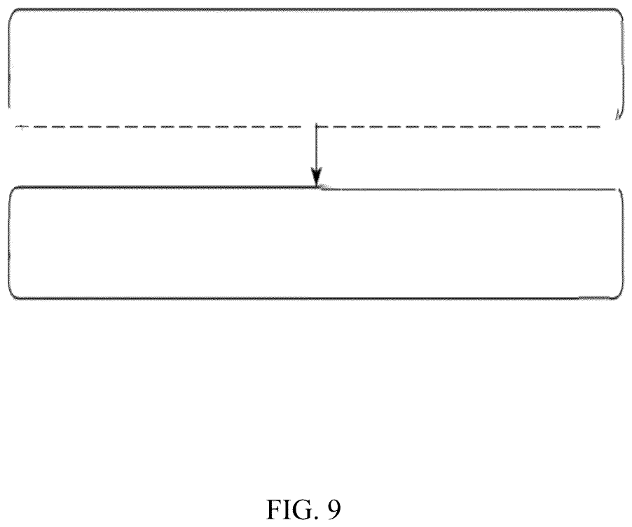

Further, referring to FIG. 9. S3) for configuring the nodes on the directed graph further includes: 3.1) inserting clock models at the nodes on the directed graph, and 3.2) configuring a phase shift for a primary clock′.

Further, S3.1 includes: 3.1.1) labeling a plurality of nodes on the directed graph as group A and group B; 3.1.2) modifying the nodes that are labeled as group A; and 3.1.3) modifying the nodes that are labeled as group B.

It should be noted that, to solve the technical problem proposed by the present invention, the present invention provides two clock models functionally capable of equivalently replacing sequential cells in an IC design, and adopts clock models to the technical problem, wherein, the nodes being labeled as group A are substituted with clock models_{[CA]}, and the nodes being labeled as group B are substituted with clock models_{[CB]}. The clock model_{[CA]} reproduces the function of the sequential cell in the IC design by controlling outputting time of a data sample, and the clock model_{[CB]} reproduces the function of the sequential cell in the IC design by controlling data sampling time.

Preferably, in S3.1.1, grouping can be performed in view of user designation, or in view of random designation or in other manners.

Wherein, S3.1.2 further includes the steps of: i) configuring the clock model_{[CA]}, which includes a data input_{[CA]}, a data output_{[CA]}, a user enable_{[CA]} and a clock input_{[CA]}.
ii) modifying a node_{[A]} in the plurality of nodes being labeled as group A. including: ii.1) identifying a logic path by which the node_{[A]} is defined in view of S2, wherein: an endpoint of the logic path is located at a user-clock input_{[A]}; the other endpoint of the logic path is located at a data output_{[A]}; and a user clock_{[A]} is connected to the user-clock input_{[A]}; ii.2) inserting the clock model_{[CA]} at the node_{[A]}, including: connecting the data input_{[CA]} to what was connected to the data input_{[A]}; connecting the data output_{[CA]} to what was connected to the data output_{[A]}; connecting the user enable_{[CA]} to what was connected to the user-clock input_{[A]}; and connecting the clock input_{[CA]} to a primary clock′ which is equal to or greater than the primary clock in frequencies to facilitate emulation of a primary clock with low frequency or behavior of a generated clock by a primary clock′ with high frequency. It should be noted that, the data input_{[CA]}, the data output_{[CA]} and the user enable_{[CA]} reserved in the clock model_{[CA]} are respectively in one-by-one correspondence to a data input_{[A]}, a data output_{[A]} and a user enable_{[A]} of a sequential cell in an IC design. It can be realized that the sequential cell[A] can be directly substituted with the clock model_{[CA]} in modification without changing other circuits connected to the sequential cells in an IC design.

Preferably, the clock frequency of the primary clock′ is twice over that of the primary clock.

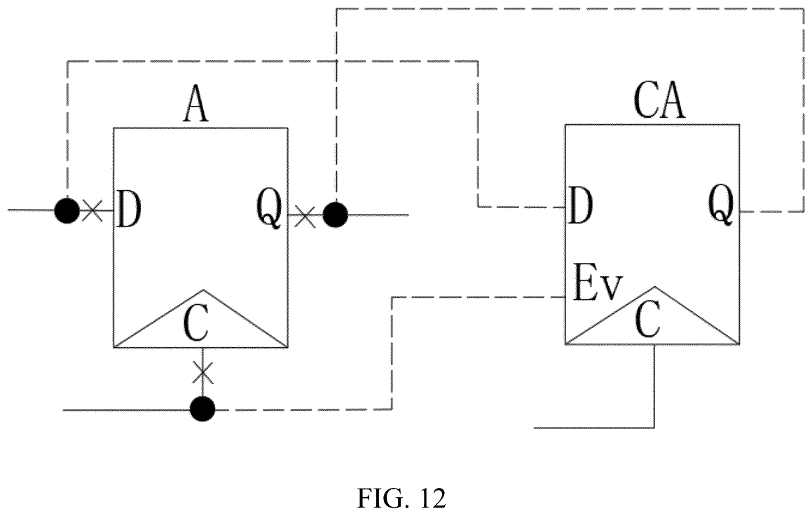

Referring to FIG. 12, to better understand Sii.2, FIG. 12 shows a schematic drawing of a sequential cell_{[A]} corresponding to a node_{[A]} and for which a clock model_{[CA]} is substituted. It should be noted that, the external port of the sequential cell_{[A]} includes a data input_{[A]}, a user-clock input_{[A]} and a data output_{[A]}. In FIG. 12, D represents the data input_{[A]} of the sequential cell_{[A]}, C represents the user-clock input_{[A]} of the sequential cell_{[A]}, and Q represents the data output_{[A]} of the sequential cell_{[A]}. In the following description, the data input_{[D]} of the sequential cell_{[A]} refers to the data input_{[A]} of the sequential cell_{[A]}, the user-clock input_{[C]} of the sequential cell_{[A]} refers to the user-clock input_{[A]} of the sequential cell_{[A]}, and the data output_{[Q]} of the sequential cell_{[A]} refers to the data output_{[A]} of the sequential cell_{[A]}. In FIG. 12. X represents disconnection, imaginal lines represent wiring the sequential cell_{[A]} after being substituted with a clock model_{[CA]}, disconnecting any one signal line of the sequential cell_{[A]} and connecting the signal line to a corresponding port of the clock model_{[CA]}, equivalently, the corresponding port of the clock model_{[CA]} replaces the port of the sequential cell_{[A]} and is connected to corresponding signal line. In FIG. 12, the clock signal line is disconnected from a user clock input_{[C]} of the sequential cell_{[A]} and connected to the user enable_{[E]} of the clock model_{[CA]}, equivalently, the user enable_{[E]} of the clock model_{[CA]} replaces the user clock input_{[C]} of the sequential cell_{[A]} such that the user enable_{[E]} of the clock model_{[CA]} is connected to a primary clock. And so on, the data input_{[D]} of the clock model_{[CA]} replaces the data input_{[D]} of the sequential cell_{[A]} such that the data input_{[D]} of the clock model_{[CA]} is accessed with data input signal; the data output_{[Q]} of the clock model_{[CA]} replaces the data output_{[Q]} of the sequential cell_{[A]} such that the data output_{[Q]} of the clock model_{[CA]} is connected to the outputted next-stage circuit; and the primary clock′ is connected to the clock input of the clock model_{[CA]}, so as to achieve the purpose of replacing a sequential cell_{[F]} with the clock model_{[CA]}.

The primary clock′ is directly connected to the clock input_{[CA]} of the clock model_{[CA]}; there is no combinatorial logic between the primary clock′ and the clock input_{[A]} of the clock model_{[CA]}, so that delay is not introduced to the clock input_{[CA]} and glitches are not present at the clock input_{[CA]} of the clock model_{[CA]}. The glitch-containing user clock is connected to a user enable_{[CA]} of the clock model_{[CA]}, while the user clock connected to the user enable_{[CA]} needs to meet the requirements of setup time and retention time, wherein the setup time refers to the time when the data remains stable until an active edge of primary clock′ arrives, the retention time refers to the time when the data remains stable after the active edge of the primary clock′ arrives, while the glitch has generally short retention time, which cannot meet the requirements of setup time and retention time, and can be shielded, so that the glitch in a user clock in the user enable_{[CA]} of the clock model_{[CA]} is no longer harmful and will not affect data sampling, and the glitch problem can be solved by the clock model_{[CA]}.
ii.3) configuring the clock model_{[CA]}, including: configuring the clock model_{[CB]}, including: sampling a signal from the data input_{[CA]} at an active edge of the primary clock′ to obtain a data sample for a period of the primary clock′ led by the active edge; when an N-th active edge is occurring on the user clock_{[A]}: obtaining a data sample_{[N]} for a contemporary period of the primary clock′; and outputting to the data output_{[CA]} the data sample_{[N]} until an N+1-th active edge occurs on the user clock_{[A]}; and when the N+1-th active edge is occurring on the user clock_{[A]}: obtaining a data sample_{[N+1]} for a contemporary period of the primary clock′; and outputting to the data output_{[CA]} the data sample_{[N+1]} until an N+2-th active edge occurs on the user clock_{[A]}. It should be noted that, the clock model_{[CA]} performs data sampling at each active edge of the primary clock′, but the outputted data sample is controlled by the user clock_{[A]}, the final effect is to output the new a data sample when the user clock_{[A]} is active, otherwise output the last output data sample. This function reproduces the function of the sequential cell. It should be noted that the clock model_{[CA]} will sample the input data signal at each active edge of the primary clock′, but outputting of the data sample sampled for which period is controlled by the user clock_{[A]}, that is, the clock model_{[CA]} reproduces the function of the sequential cell in an IC design by controlling outputting time of the data sample.

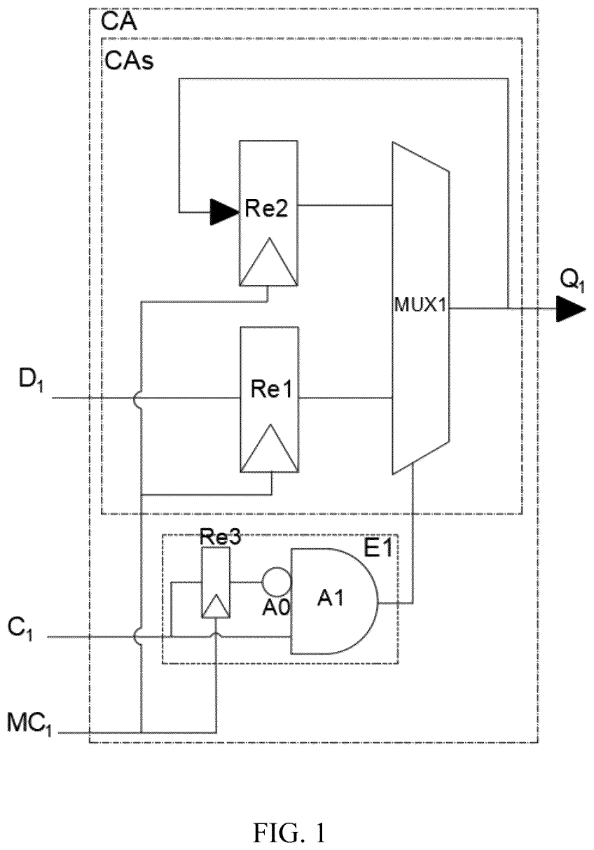

Preferably, referring to FIG. 1 showing the structure of a clock model_{[CA]} again, the clock model_{[CA]} includes a clock detector_{[E1]} and a sampler_{[CAs]}. As shown in FIG. 1, D₁ represents data signal connected to the clock input_{[CA]}, C₁ represents the user clock_{[A]} connected to the user enable_{[CA]}, MC₁ represents the primary clock′ connected to the clock input_{[CA]}, Q₁ represents the data signal output from the data output_{[CA]}. Namely, the user enable_{[E1]} is connected to C₁, the clock input_{[E1]} is connected to MC₁, the active-edge output of E1 is connected to an enable_{[CAs]}, the data input_{[CA]} is connected with D₁, and the data output_{[CAs]} is connected with Q₁. Wherein, S4.1.2 further includes: configuring for the clock model_{[CA]} a clock detector_{[E1]} and a sampler_{[CAs]}; configuring for the clock detector_{[E1]} a user enable_{[E1]}, a clock input_{[E1]} and an active-edge output_{[E1]}; configuring for the sampler_{[CAs]} a data input_{[CAs]}, an enable_{[CAs]}, a clock input_{[CAs]} and a data output_{[CAs]}; connecting the user enable_{[E1]} to the user enable_{[CA]}; connecting the clock input_{[E1]} and the clock input_{[CAs]} to the clock input_{[CA]}; connecting the active-edge output_{[E1]} to the enable_{[CAs]}; connecting the data input_{[CAs]} to the data input_{[CA]}; and connecting the data output_{[CAs]} to the data output_{[CA]}.

Wherein, the clock detector_{[E1]} is used for detecting whether active edge occurs or not; the sampler_{[CAs]} is used for sampling signals from the data input_{[CA]} at each active edge of the primary clock′ to obtain data sample for a period of the primary clock′ led by the active edge; when an N-th active edge is occurring on the user clock_{[A]}: obtaining a data sample_{[N]} for a contemporary period of the primary clock′; and outputting to the data output_{[CA]} the data sample_{[N]} until an N+1-th active edge occurs on the user clock_{[A]}; and when the N+1-th active edge is occurring on the user clock_{[A]}: obtaining a data sample_{[N+1]} for a contemporary period of the primary clock′; and outputting to the data output_{[CA]} the data sample_{[N+1]} until an N+2-th active edge occurs on the user clock_{[A]}, wherein the active edge of the user clock output by the clock detector_{[E1]} is used for driving the sampler_{[CAs]} to output corresponding data sample.

Further, preferably, referring to FIG. 1 again, S3.1.2 further includes: configuring for the sampler_{[CAs]} a first state holder_{[Re1]}, a second state holder_{[Re2]} and a multiplexer_{[MUX1]}; configuring for the first state holder_{[Re1]} a clock input_{[Re1]}, a data input_{[Re1]} and a data output_{[Re1]}; configuring for the second state holder_{[Re2]} a clock input_{[Re2]}, a data input_{[Re2]} and a data output_{[Re2]}; configuring for the multiplexer_{[MUX1]} a first data input_{[MUX1]}, a second data input_{[MUX1]}, a signal selection_{[MUX1]} and a data output_{[MUX1]}; connecting the data input_{[Re1]} to the data input_{[CAs]}; connecting the data output_{[MUX1]} to the data output_{[CAs]}; connecting the clock input_{[Re1]} and the clock input_{[Re2]} to the clock input_{[CAs]}; connecting the data output_{[Re1]} to the first data input_{[MUX1]}; connecting the data input_{[Re2]} to the data output_{[MUX1]}; connecting the data output_{[Re2]} to the second data input_{[MUX1]}; and connecting the enable_{[CAs]} to the signal selection_{[MUX1]}.

Wherein, the multiplexer is configured to be a combinational logic circuit with a plurality of data inputs and single data output. The multiplexer with a plurality of data inputs is a multi-channel digital switch, and can select one data input signal from the plurality of data inputs according to different signals of a signal selection and output to a common data output.

Wherein, the first state holder_{[Re1]} is used for realizing sampling of data signal from the data input_{[CA]} when each active edge of the primary clock′ occurs to obtain data sample. The second state holder_{[Re2]} is used for realizing sampling of data signal from the data input_{[CA]} when each active edge of the primary clock′ occurs to obtain data sample, wherein the primary clock′ is greater than the user clock in clock frequencies, and the first state holder_{[Re1]} and the second state holder_{[Re2]} are connected to the same one primary clock′. Two kinds of data samples are obtained at each active edge of the primary clock′, including: the data sample obtained at contemporary period of the primary clock′ and outputted from the first state holder_{[Re1]}, and the data sample obtained at previous one period of the primary clock′ and outputted from the second state holder_{[Re2]}. The multiplexer_{[MUX1]} is used for selectively outputting the data sample of first state holder_{[Re1]} when the user clock_{[A]} is active and outputting the data sample of the second state holder_{[Re2]} when the user clock_{[A]} is inactive. That is, when the i-th active edge of primary clock′ arrives, the first state holder_{[Re1]} samples the input data to obtain data sample 1, if the user clock_{[A]} is active at this time, and the multiplexer_{[MUX1]} is driven to select the data sample of the first state holder_{[Re1]} to output the data 1; when the (i+1)-th active edge of primary clock′ arrives, the first state holder_{[Re1]} continues to sample the input data to obtain the new data sample 2, but at this time the second state holder_{[Re2]} samples the data 1 output by the multiplexer_{[MUX1]} to obtain data 1, if the user clock_{[A]} is inactive at this time, the multiplexer_{[MUX1]} is driven to select the data sample of the second state holder_{[Re2]} to output data 1, and when the (i+2)-th active edge of primary clock′ arrives, if the user clock is active, the multiplexer_{[MUX1]} is driven to output the new data sample 2, otherwise continue to output data 1, so as to achieve that: when the N-th active edge is occurring on the user clock_{[A]}: the data sample N of the primary clock′ in the contemporary period is obtained and output to the data output_{[CA]} until the (N+1)-th active edge is occurring on the user clock_{[A]}; and when the (N+1)-th active edge is occurring on the user clock_{[A]}: the data sample N+1 of the primary clock′ in the contemporary period is obtained and output to the data output_{[CA]} until the (N+2)-th active edge is occurring on the user clock_{[A]}.

Further, preferably, referring to FIG. 1 again, a clock detector_{[E1]} is configured for a third state holder_{[Re3]}, a non-gate circuit_{[A]} and an AND gate circuit_{[A1]}, including: configuring for the third state holder_{[Re3]} a clock input_{[Re3]}, a data input_{[Re3]} and a data output_{[Re3]}; configuring for the non-gate circuit a signal input_{[A]} and a signal output_{[A0]}; configuring for the AND gate circuit a first data input_{[A1]}, a second data input_{[A1]} and a data output_{[A1]}; connecting the clock input_{[Re3]} to the clock input_{[E1]}; connecting the data input_{[Re3]} and the first data input_{[A1]} to the user enable_{[E]}; connecting the data output_{[Re3]} to the signal output_{[A0]}; connecting the signal output_{[A0]} to second data input_{[A1]}; and connecting the data output_{[A1]} to an active-edge output_{[E1]}.

Wherein, the gate circuit_{[A0]} is used for realizing that logic output from the signal output_{[A0]} is opposite to that output from the signal input_{[A0]}. The AND gate circuit_{[A1]} is used for realizing that: the data output_{[A1]} outputs high logic when the first data input_{[A1]} and the second data input_{[A1]} are at high logic state simultaneously, otherwise, the data output_{[A1]} outputs low logic.

Preferably, the combinational circuit of the non-gate circuit_{[A0]} and the AND gate circuit_{[A1]} can comprise lookup tables with the same truth table, wherein the digital combinational circuit realizing lookup tables with the same truth table comprises various types, wherein the lookup table is a structure used to implement the truth table that has written all possible logic combinations and their corresponding logic results in advance. The corresponding logic results can be obtained according to the logic combinations at the input of the lookup table.

Preferably, an active edge of a user clock is configured to a rising edge or falling edge.

Preferably, active edges of the primary clocks' by which the clock model_{[CA]} and the clock model_{[CB]} are driven are configured to be triggered by a rising edge or configured to be triggered by falling edge, or the clock model_{[CA]} is configured to be triggered by a rising edge and the clock model_{[CB]} is configured to be triggered by falling edge, or the clock model_{[CA]} is configured to be triggered by a falling edge and the clock model_{[CB]} is configured to be triggered by rising edge. When the active edge is configured to be triggered by a rising edge, the clock detector adopts a clock detector for detecting a rising edge, such as the clock detector_{[E1]} in FIG. 1. When the active edge is configured to be triggered by a falling edge, the clock detector adopts a clock detector for detecting a falling edge. In this case that the clock detector adopts a clock detector for detecting a falling edge, the differences between the clock detector_{[E1]} and the clock detector_{[E2]} are that: the data output_{[Re3]} of the third state holder_{[Re3]} is directly connected to the second data input_{[A1]} of a gate circuit, a non-gate circuit_{[A0]} is configured such that the non-gate input of the non-gate circuit is connected to the user enable_{[E1]}, and the non-gate output is connected to the first data input_{[A1]} of the gate circuit. All clock detectors capable of detecting rising edges, falling edges or bilateral edges in the prior art fall within the protection scope of the present invention.

The clock model_{[CA]} can not only reproduce the function of the sequential cell, but also directly performs data sampling after an active edge of the primary clock arrives owing to its internal structure, and only selectively outputs the corresponding sampling results, so that there is no delay problem on the sampling time of the clock model_{[CA]}.

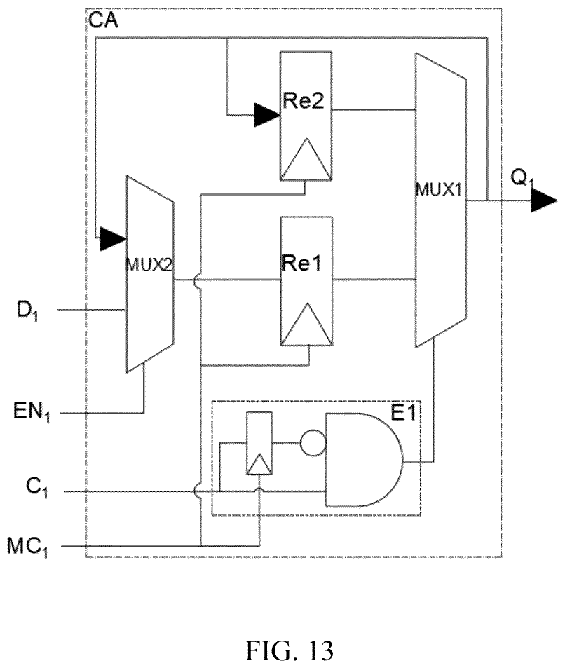

Preferably, when an enable of a sequential cell is connected to a circuit, referring to FIG. 13, D₁ represents data signal of the data input_{[CA]}, Q₁ represents the data sample output from the data output_{[CA]}, C₁ represents the user clock connected to the user enable_{[CA]}, MC₁ represents the clock signal connected to the clock input_{[CA]}, EN₁ represents the enable signal connected to the enable_{[CA]}. S2.1 further includes identifying on the sequential cell, a data input, a user-clock input, a data output and an enable. S4.1.2 further includes: configuring for the clock model_{[CA]} a data input_{[CA]}, a data output_{[CA]}, a user enable_{[CA]}, a clock input_{[CA]} and an enable_{[CA]}; configuring for the clock model_{[CA]} a clock detector_{[E1]}, a first state holder_{[Re1]}, a second state holder_{[Re2]}, a multiplexer_{[MUX1]} and a multiplexer_{[MUX2]}; configuring for the clock detector_{[E1]} a user enable_{[E1]}, a clock input_{[E1]} and an active-edge output_{[E1]}; configuring for the first state holder_{[Re1]} a clock input_{[Re1]}, a data input_{[Re1]} and a data output_{[Re1]}; configuring for the second state holder_{[Re2]} a clock input_{[Re2]}, a data input_{[Re2]} and a data output_{[Re2]}; configuring for the multiplexer_{[MUX1]} a first data input_{[MUX1]}, a second data input_{[MUX1]}, a signal selection_{[MUX1]} and a data output_{[MUX1]}; configuring for the multiplexer_{[MUX2]} a first data input_{[MUX2]}, a second data input_{[MUX2]}, a signal selection_{[MUX2]} and a data output_{[MUX2]}; connecting the second data input_{[MUX2]} to the data input_{[CA]}; connecting the data output_{[MUX1]} to the data output_{[CA]}, the data input_{[Re2]} and the first data input_{[MUX2]}; connecting the second data input_{[MUX2]} to the data input_{[CA]}; connecting the data output terminal_{[MUX1]} to the data output_{[CA]}, the data input_{[Re2]} and the first data input_{[MUX2]}; connecting the clock input_{[Re1]}, the clock input_{[Re2]} and the clock input_{[E1]} to the clock input_{[CA]}; connecting the user enable_{[E1]} to the user enable_{[CA]}; connecting the active-edge output_{[E1]} to the signal selection_{[MUX1]}; connecting the data output_{[Re2]} to the second data input_{[MUX1]}; connecting the enable_{[CA]} to the signal selection_{[MUX2]}; connecting the data output_{[MUX2]} to the data input_{[Re1]}; and connecting the data output_{[Re1]} to the first data input_{[MUX1]}. It should be noted that, when the enable signal assessed to the enable_{[CA]} is active, the multiplexer_{[MUX2]} is used to realizing that: the multiplexer_{[MUX2]} is driven to selectively output data signal_{[D1]} input by the data input_{[CA]} to the data input_{[Re1]}; otherwise, is driven to selectively output the data signal_{[Q1]} output by the data output_{[CA]} to the data input_{[Re1]}.

Preferably, the first state holder_{[Re1]} is configured to be a register or a latch, and the second state holder_{[Re2]} is configured to be a register or a latch.
iii) modifying the rest of nodes_{[A]} in the plurality of nodes being labeled as group A.

Wherein, S3.1.3 further includes the steps of:
i) configuring the clock model_{[CB]}, which includes a data input_{[CB]}, a data output_{[CB]}, a user enable_{[CB]} and a clock input_{[CB]}.
ii) modifying a node_{[B]} in the plurality of nodes being labeled as group B, including:
ii.1) identifying a logic path by which the node_{[B]} is defined in view of S2, wherein: an endpoint of the logic path is located at a user-clock input_{[B]}; the other endpoint of the logic path is located at a data output_{[B]}; and the user clock_{[B]} is connected to the user-clock input_{[B]}.
ii.2) inserting a clock model_{[CB]} at the node_{[B]}, including: connecting the data input_{[CB]} to what was connected to the data input_{[B]}; connecting the data output_{[CB]} to what was connected to the data output_{[B]}; connecting the user enable_{[CB]} to what was connected to the user-clock input_{[B]}; and connecting the clock input_{[CB]} to a primary clock′ which is equal to or greater than the primary clock in frequencies. It should be noted that, the same objective as the clock model_{[CA]}, the data input_{[CB]}, the data output_{[CB]} and the user enable_{[CB]} reserved in the clock model_{[CB]} are respectively in one-by-one correspondence to a data input_{[B]}, a data output_{[B]} and a user enable_{[B]} of a sequential cell in an IC design. It can be realized that the sequential cell_{[B]} can be directly substituted with the clock model_{[CB]} in modification without changing other circuits connected to the sequential cells in an IC design.

It should be described that, the external ports of the clock model_{[CA]} and the clock model_{[CB]} are the same, so that substitution method is similar to the method shown in FIG. 11, and here detailed description is avoided.

The primary clock′ is directly connected to the clock input_{[CB]} of the clock model_{[CB]}, the glitch-containing user clock is connected to the user enable_{[CB]} of the clock model_{[CB]}, the clock model_{[CB]} and the clock model_{[CB]} have the same principle of solving technical problem, there is no glitch in the primary clock′ connected to the clock input_{[CB]}, the glitch-containing user clock is connected to the glitch-insensitive user enable_{[CB]}, and the glitch does not affect data sampling, so that the clock model_{[CB]} solves the glitch problem.
ii.3) configuring the clock model_{[CB]}, including: when an active edge is occurring on the user clock_{[B]} and when an active edge is occurring on the primary clock′: sampling a signal from the data input_{[CB]} to obtain a data sample for a period of the primary clock′ led by the active edge; and; and when no active edge occurs on the user clock_{[B]} or no active edge occurs on the primary clock′: sampling nothing from the data input_{[CB]}; and outputting nothing to the data output_{[CB]}. It should be noted that, the clock model_{[B]} is lower than the primary clock′ in frequencies, and sampling is performed only when the active edge occurs on the user clock_{[B]} and the active edge occurs on the primary clock′, that is, the user clock_{[B]} reproduces the function of the sequential cell in an IC design by controlling sampling time of a data sample.

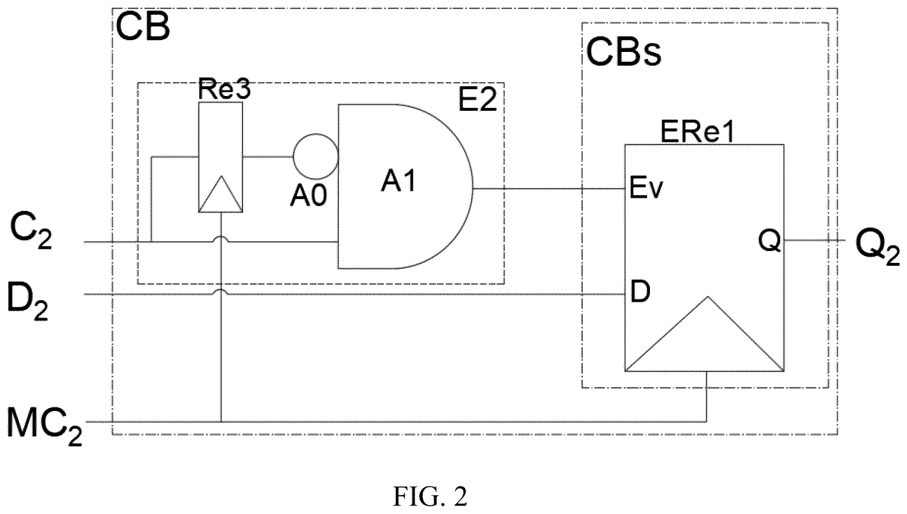

Preferably, referring to FIG. 2, wherein, S3.1.3 further includes: configuring for the clock model_{[CB]} a clock detector_{[E2]} and a sampler_{[CBs]}; configuring for the clock detector_{[E2]} a user enable_{[E2]}, a clock input_{[E2]} and an active-edge output_{[E2]}; configuring for the sampler_{[CBs]} a clock input_{[CBs]}, an enable_{[CBs]}, a data input_{[CBs]} and a data output_{[CBs]}; connecting the data input_{[CBs]} to the data input_{[CB]}; connecting the data output_{[CBs]} to the data output_{[CB]}; connecting the clock input_{[E2]} and the clock input_{[CBs]} to the clock input_{[CB]}; connecting the user enable_{[E2]} to the user enable_{[CB]}; and connecting the active-edge output_{[E2]} to the enable_{[CBs]}.

The function of the clock detector_{[E2]} is the same as that of the clock detector_{[E1]}, the internal structure of the clock detector_{[E2]} is the same as that of the clock detector_{[E1]}, and here detailed description is avoided.

Wherein, the sampler_{[CBs]} is used for sampling a signal from the data input_{[CB]} when an active edge is occurring on the user clock_{[B]} and the active edge is occurring on the primary clock′ to obtain a data sample for a period of the primary clock′ led by the active edge, and; and when no active edge occurs on the user clock_{[B]} or no active edge occurs on the primary clock′: sampling nothing from the data input_{[CB]}, and outputting nothing to the data output_{[CB]}.

Circuits for realizing the sampler CBs can be configured to be various types. The examples in the present invention provide two deformation methods.

Preferably, the sampler_{[CBs]} is configured to be a register_{[ERe1]} having an enable. The clock model_{[CB]} has simple internal structure, and the clock model_{[CA]} is realized by combination of more hardware. Compared with the clock model_{[CA]}, the clock model_{[CB]} can save a lot of hardware resources, so that the clock model_{[CA]} and the clock model_{[CB]} are cooperated to realize balance of hardware resources.

Preferably, the clock model_{[CB]} includes a register_{[ERe1]} and a clock detector_{[E2]}, wherein the register_{[ERe1]} is configured to be a register having an enable, and the output of the clock detector_{[E2]} is connected to the enable of the register.

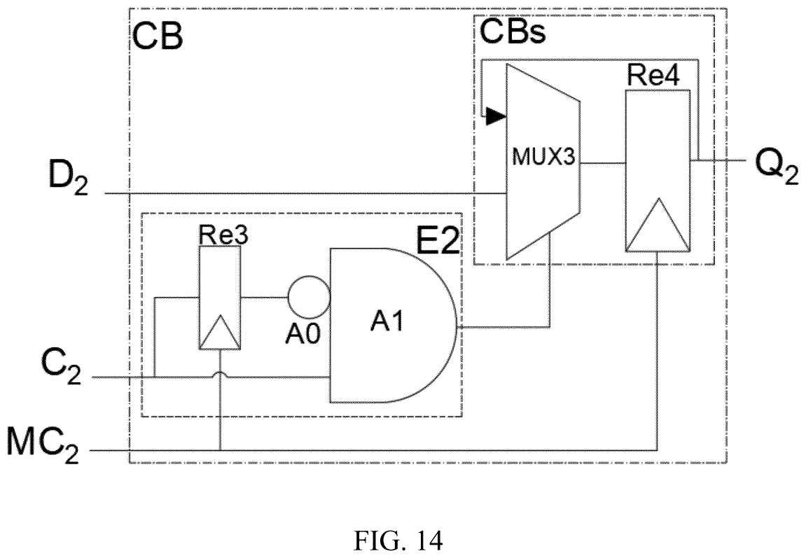

Preferably, referring to FIG. 14, S3.1.3 further includes: configuring for the sampler_{[CBs]} a fourth state holder_{[Re4]} and a multiplexer_{[MUX3]}; configuring for the fourth state holder_{[Re4]} a clock input_{[Re4]}, a data input_{[Re4]} and a data output_{[Re4]}; configuring for the multiplexer_{[MUX3]} a first data input_{[MUX3]}, a second data input_{[MUX3]}, a signal selection_{[MUX3]} and a data output_{[MUX3]}; connecting the first data input_{[MUX3]} to the data input_{[CBs]}; connecting the data output_{[Re4]} to the second data input_{[MUX3]} and to the data output_{[CBs]}; connecting the clock input_{[Re4]} to the clock input_{[CBs]}; connecting the signal selection_{[MUX3]} to the enable_{[CBs]}; and connecting the data output_{[MUX3]} to the data input_{[Re4]}. The combined function of the multiplexer_{[MUX3]} and the fourth state holder_{[Re4]} is equivalent to the function of the register_{[ERe1]} having an enable. The multiplexer_{[MUX3]} is used for selecting the data signal input by the data input_{[CBs]} when the user signal is active to output to the fourth state holder_{[Re4]}, otherwise, selecting the data signal output from the data output_{[CBs]} to output to the fourth state holder_{[Re4]}, and sampling the data signal from the data input_{[Re4]} when the primary clock′ is active to output. It should be noted that, the clock model_{[CB]} is a clock model having clock delay relative to the clock model_{[CA]}, and the clock delay of the clock model_{[CB]} is delay caused by the hardware structure of the clock model_{[CB]} itself.

Preferably, the fourth state holder_{[Re4]} is configured to be a register or a latch.

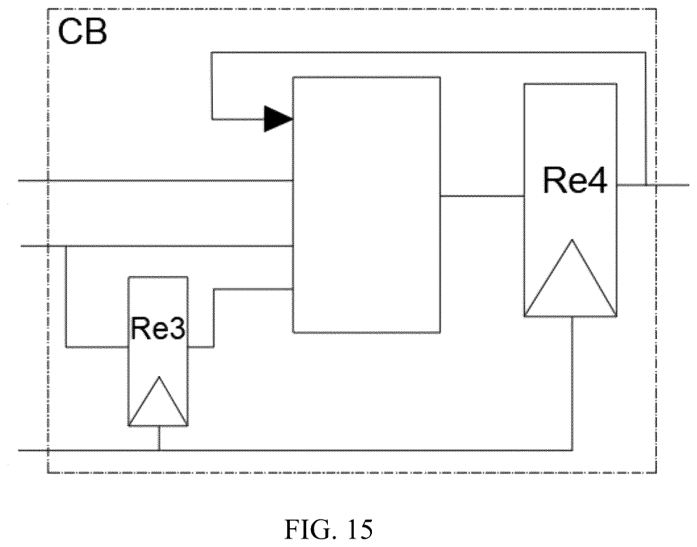

Preferably, the clock model_{[CB]} also can be functional module composed of other structures, referring to FIG. 15, configuring for the clock model_{[CB]} a third state holder_{[Re3]}, a fourth state holder_{[Re4]} and a lookup table_{[LUT1]}; configuring for the third state holder_{[Re3]} a clock input_{[Re3]}, a data input_{[Re3]} and a data output_{[Re3]}; configuring for the fourth state holder_{[Re4]} a clock input_{[Re4]}, a data input_{[Re4]} and a data output_{[Re4]}; configuring for the lookup table_{[LUT1]} a first data input_{[LUT1]}, a second data input_{[LUT1]}, a third data input_{[LUT1]}, a fourth data input_{[LUT1]} and a data output_{[LUT1]}; connecting the second data input_{[LUT1]} to the data input_{[B]}; connecting the data output_{[Re4]} to the first data input_{[LUT1]} and the data output_{[CB]}; connecting the clock input_{[Re3]} and the clock input_{[Re4]} to the clock input_{[CB]}; connecting the data input_{[Re3]} and the third data input_{[LUT1]} to the user enable_{[CB]}; connecting the data output_{[Re3]} to the fourth data input_{[LUT1]}; and connecting the data output_{[LUT1]} to the data input_{[Re4]}. It should be noted that, the function of the lookup table_{[LUT1]} is equivalent to that of the non-gate circuit_{[A]} in FIG. 14, and an AND gate circuit_{[A1]} and a multiplexer_{[MUX3]} have a combined function of a module. The first to fourth data inputs of the lookup table_{[LUT1]} are equivalent to the signal input_{[A]}, the first data input_{[A1]}, the first data input_{[MUX3]} and the second data input_{[MUX3]}. The data output_{[LUT1]} of the lookup table_{[LUT1]} is equivalent to the data output_{[Re4]} in FIG. 12, that is, the function of pre-written truth table of the lookup table_{[LUT1]} is equivalent to the combined function of the AND gate circuit_{[A1]} and the multiplexer_{[MUX3]}.

The third state holder_{[Re3]} is configured to be a register or a latch.

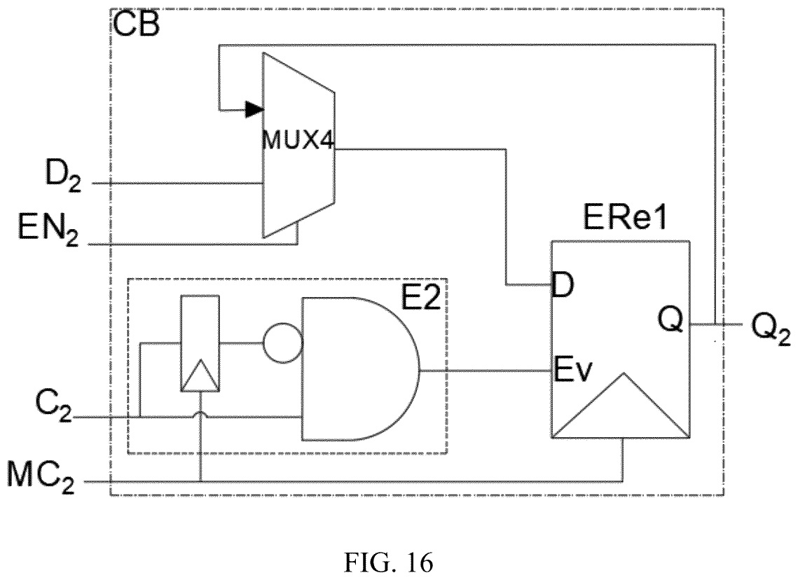

Preferably, when an enable of a sequential cell is connected to a circuit, referring to FIG. 16, S2.1 further includes: identifying on the sequential cell: a data input, a user-clock input, a data output and an enable. S4.1.3 further includes: configuring for the clock model_{[CB]} a data input_{[CB]}, a data output_{[CB]}, a user enable_{[CB]}, a clock input_{[CB]} and an enable_{[CB]}; configuring for the clock model_{[CB]} a clock detector_{[E2]}, a memory cell_{[ERe1]} and a multiplexer_{[MUX4]}; configuring for the clock detector_{[E2]} a user enable_{[E2]}, a clock input_{[E2]} and an active-edge output_{[E2]}; configuring for the memory cell_{[ERe1]} a clock input_{[ERe1]}, an enable_{[ERe1]}, a data input_{[ERe1]} and a data output_{[ERe1]}; configuring for the multiplexer_{[MUX4]} a first data input_{[MUX4]}, a second data input_{[MUX4]}, a signal selection_{[MUX4]} and a data output_{[MUX4]}; connecting the second data input_{[MUX4]} to the data input_{[CB]}; connecting the signal selection_{[MUX4]} to the enable_{[CB]}; connecting the data output_{[ERe1]} to the data output_{[CB]} and to the first data input_{[MUX4]}; connecting the clock input_{[E2]} and the clock input_{[ERe1]} to the clock input_{[CB]}; connecting the user enable_{[E2]} to the user enable_{[CB]}; connecting the active-edge output_{[E2]} to the enable_{[ERe1]}; and connecting the data output_{[MUX4]} to the data input_{[ERe1]}. In FIG. 16, D₂ represents a data signal connected to the data input_{[CB]}, Q₂ represents the data sample output from the data output_{[CB]}, C₂ represents the user clock connected to the user enable_{[CB]}, MC₂ represents a clock signal connected to the clock input_{[CB]}, and EN₂ represents the enable signal connected to the enable_{[CB]}. It should be noted that, when the enable signal connected to the enable_{[CB]} is active, the multiplexer_{[MUX4]} is driven to output the data signal_{[D2]} input by the data input_{[CB]} to the data input_{[ERe1]}, otherwise, the multiplexer_{[MUX4]} is driven to output the data signal_{[Q2]} output from the data output_{[CB]} to the data input_{[ERe1]}.

Preferably, an active edge is configured to a rising edge or falling edge, wherein, the active edge is the active edge triggered by the user clock and/or the active edge triggered by the primary clock′.

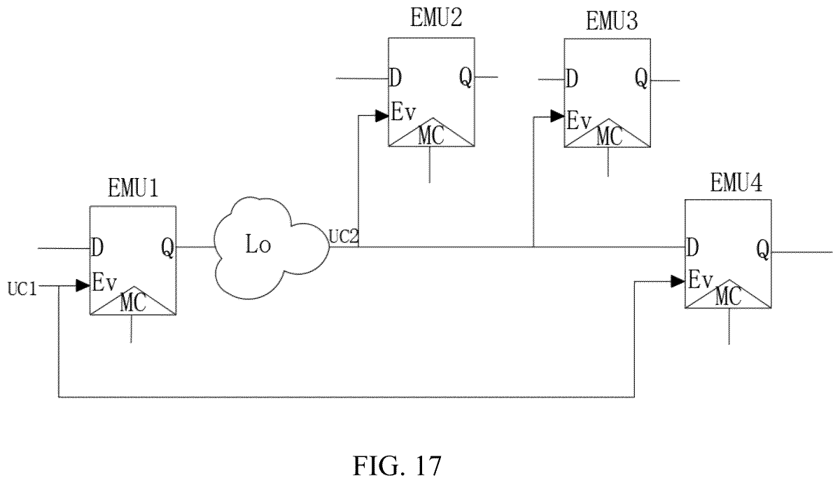

In an IC design, there are anchor points in the combinational logics among sequential cells. The anchor point is the generated clock, which is output by the sequential cell, processed by the combinational logic circuit and then processed by a plurality of branch output ports, and each branch output port is called as an anchor point, and each anchor point is connected to the clock input of the corresponding clock model. Since the user clocks connected to the same anchor point are exactly the same, the results of the user clock active edges of the same user clock output through the clock detector of different clock models are the same, thereby saving hardware resources. The clock models connected to the same anchor point are configured to share a same clock detector to detect an active edge of a user clock. As an example, in order to better understand the anchor point in the present invention, referring to FIG. 17, four modified clock models_{[EMU1-[EMU4]} are provided in FIG. 17. The clock models_{[EMU1]} can be the clock model_{[CA]} or the clock model_{[CB]}. The clock model_{[CA]} and the clock model_{[CB]} is pre-reserved with the same external port. In FIG. 15, D represents a data input, Q represents a data output, Ev represents a user enable, and MC represents a clock input, wherein, the user enable_{[E1]} of the clock models_{[EMU1]} and the user enable_{[Ev]} of the clock models_{[EMU4]} are connected to the same anchor point anchor 1, the user enable_{[Ev]} of the clock models_{[EMU2]} and the user enable_{[Ev]} of the clock models_{[EMU3]} are connected to the same anchor point anchor 2, and the user clocks_{[UC1]} connected to the clock models_{[EMU1]} and the clock models_{[EMU4]} are the same, and the user clocks_{[UC2]} connected to the clock models_{[EMU2]} and the clock models_{[EMU3]} are the same. For the clock detector, when the input user clocks are the same, the output results of clock detector are the same. Therefore, the clock models connected to the same user clock can share the same clock detector, that is, the clock models_{[EMU1]} and the clock models_{[EMU4]} share a same clock detector, and the clock models_{[EMU2]} and the clock models_{[EMU3]} share a same clock detector.

Combination of common clock detectors includes the following three examples.

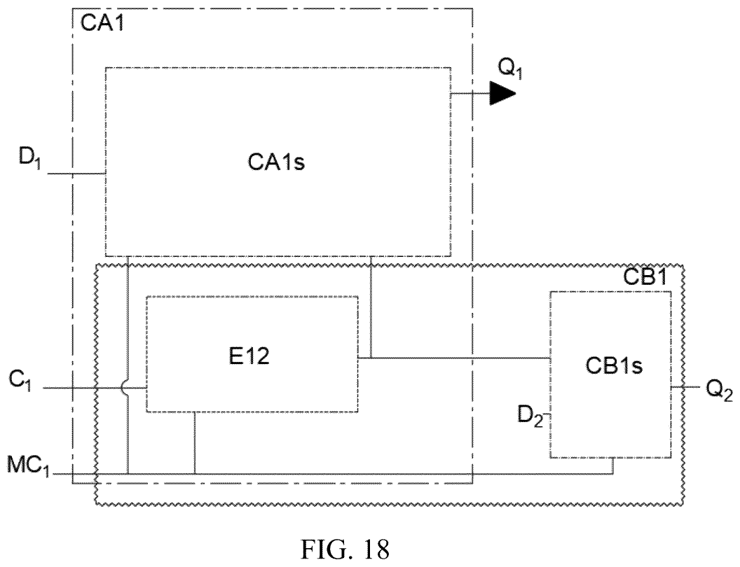

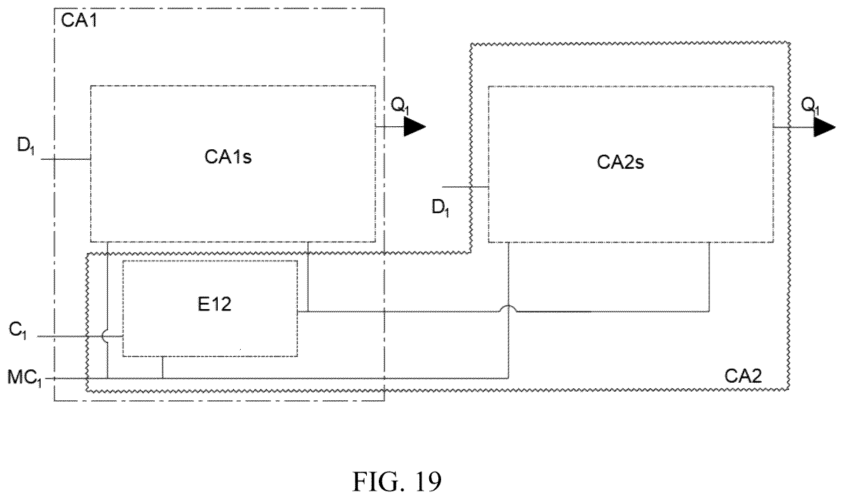

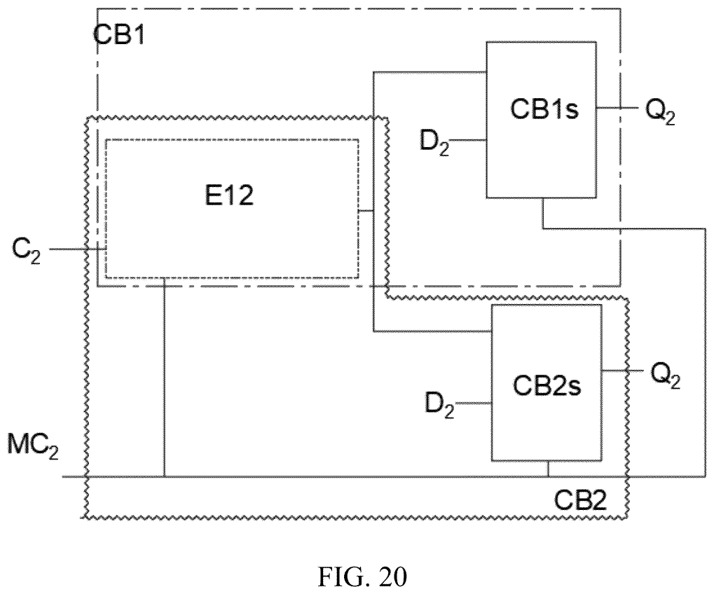

Preferably, referring to FIG. 18, in S1, the plurality of sequential cells include: a sequential cell_{[A1]} and a sequential cell_{[B1]}. in S2, on the directed graph: the sequential cell_{[A1]} is converted to a node_{[A1]}, and the sequential cell_{[B1]} is converted to a node_{[B1]}; in S3.1.1: the node_{[A1]} is labeled as group A, and the node_{[B1]} is labeled as group B; in S3.1.2: a clock model_{[CA1]} is inserted at the node_{[A1]}, and the clock model_{[CA1]} is configured to include a data input_{[CA1]}, a data output_{[CA1]}, a user enable_{[CA1]} and a clock input_{[CA1]}; in S3.1.3: a clock model_{[CB1]} is inserted at the node_{[B1]}, and the clock model_{[CB1]} is configured to include a data input_{[CB1]}, a data output_{[CB1]}, a user enable_{[CB1]} and a clock input_{[CB1]}; S3.1 further includes: configuring for the clock model_{[CA1]} a sampler_{[CA1s]}; configuring for the sampler_{[CA1s]} a data input_{[CA1s]}, an enable_{[CA1s]}, a clock input_{[CA1s]} and a data output_{[CA1s]}; configuring for the clock model_{[CB1]} a sampler_{[CB1s]}; configuring for the sampler_{[CB1s]} a data input_{[CB1s]}, an enable_{[CB1s]}, a clock input_{[CB1s]} and a data output_{[CB1s]}; identifying an anchor to which the user enable_{[CA1]} is connected; and if the user enable_{[CB1]} is connected to the anchor: configuring jointly for the clock model_{[CA1]} and for the clock model_{[CB1]} a clock detector_{[E12]}; configuring for the clock detector_{[E12]} a user enable_{[E12]}, a clock input_{[E12]} and an active-edge output_{[E12]}; connecting the user enable_{[E12]} to the anchor, the user enable_{[CA1]} and the user enable_{[CB1]}; connecting the clock input_{[E12]} to the clock input_{[CA1s]}, the clock input_{[CA1]}, the clock input_{[CB1s]} and the clock input_{[CB1]}; connecting the active-edge output_{[E12]} to the enable_{[CA1s]} and to the enable_{[CB1s]}; connecting the data input_{[CA1s]} to the data input_{[CA1]}; connecting the data output_{[CA1s]} to the data output_{[CA1]}; connecting the data input_{[CB1s]} to the data input_{[CB1]}; and connecting the data output_{[CB1s]} to the data output_{[CB1]}. As shown in FIG. 18, C₁ represents both the user clock_{[A]} connected to the user enable_{[CA1]} and the user clock_{[B]} connected to the user enable_{[CB1]}; and MC₁ represents both the primary clock′ connected to the clock input_{[CA1]} and the primary clock′ connected to the clock input_{[CB1]}. By making the clock model_{[CA1]} and clock model_{[CB1]} connected to a same anchor share one clock detector, it can not only obtain the same active edge as the unshared clock detector, but also greatly reduce use of clock detectors and reduce consumption of hardware resources. Preferably, referring to FIG. 19, wherein, in S1, the plurality of sequential cells include: a sequential cell_{[A1]} and a sequential cell_{[A2]}; in S2, on the directed graph: the sequential cell_{[A1]} is converted to a node_{[A1]}, and the sequential cell_{[A2]} is converted to a node_{[A2]}; in S3.1.1, the node_{[A1]} and the node_{[A2]} are both labeled as group A; in S3.1.2: the clock model_{[CA1]} is inserted at the node_{[A1]}; and the clock model_{[CA1]} is configured to include a data input_{[CA1]}, a data output_{[CA1]}, a user enable_{[CA1]} and a clock input_{[CA1]}; a clock model_{[CA2]} is inserted at the node_{[A2]}; and the clock model_{[CA2]} is configured to include a data input_{[CA2]}, a data output_{[CA2]}, a user enable_{[CA2]} and a clock input_{[CA2]}; S3.1 further includes: configuring for the clock model_{[CA1]} a sampler_{[CA1s]}; configuring for the sampler_{[CAs1]} a data input_{[CA1s]}, an enable_{[CA1s]}, a clock input_{[CA1s]} and a data output_{[CA1s]}; configuring for the clock model_{[CA2]} a sampler_{[CA2s]}; configuring for the sampler_{[CA2s]} a data input_{[CA2s]}, an enable_{[CA2s]}, a clock input_{[CA2s]} and a data output_{[CA2s]}; identifying an anchor to which the user enable_{[CA1]} is connected; and if the user enable_{[CA2]} is connected to the anchor: configuring jointly for the clock model_{[CA1]} and for the clock model_{[CA2]} a clock detector_{[E12]}; configuring for the clock detector_{[E12]} a user enable_{[E12]}, a clock input_{[E12]} and an active-edge output_{[E12]}; connecting the user enable_{[E12]} to the anchor, the user enable_{[CA1]} and the user enable_{[CA2]}; connecting the clock input_{[E12]} to the clock input_{[CA1s]}, the clock input_{[CA1]}, the clock input_{[CA2s]} and the clock input_{[CA2]}; connecting the active-edge output_{[E12]} to the enable_{[CA1s]} and to the enable_{[CA2s]}; connecting the data input_{[CA1s]} to the data input_{[CA1]}; connecting the data output_{[CA1s]} to the data output_{[CA1]}; connecting the data input_{[CA2s]} to the data input_{[CA2]}; and connecting the data output_{[CA2s]} to the data output_{[CA2]}. As shown in FIG. 19, since the clock detector_{[E12]} is used in common, C₁ represents both the user clock_{[A]} connected to the user enable_{[CA1]} and the user clock_{[A]} connected to the user enable_{[CA2]}; and MC₁ represents both the primary clock′ connected to the clock input_{[CA1]} and the primary clock′ connected to the clock input_{[CA2]}. By making two or more clock models_{[CA]} connected to the same anchor share one clock detector, it can not only obtain the same active edge as the unshared clock detector, but also greatly reduce use of clock detectors and reduce consumption of hardware resources. Preferably, referring to FIG. 20, wherein, in S1, the plurality of sequential cells include: a sequential cell_{[B1]} and a sequential cell_{[B2]}; in S2, on the directed graph: the sequential cell_{[B1]} is converted to a node_{[B1]} and the sequential cell_{[B2]} is converted to a node_{[B2]}; in S3.1.1, the node_{[B1]} and the node_{[B2]} are both labeled as group B; in S3.1.3: a clock model_{[CB1]} is inserted at the node_{[B1]}; the clock model_{[CB1]} is configured to include a data input_{[CB1]}, a data output_{[CB1]}, a user enable_{[CB1]} and a clock input_{[CB1]}; a clock model_{[CB2]} is inserted at the node_{[B2]}; and the clock model_{[CB2]} is configured to include a data input_{[CB2]}, a data output_{[CB2]}, a user enable_{[CB2]} and a clock input_{[CB2]}; S3.1 further includes: configuring for the clock model_{[CB1]} a sampler_{[CB1s]}; configuring for the sampler_{[CB1s]} a data input_{[CB1s]}, an enable_{[CB1s]}, a clock input_{[CB1s]} and a data output_{[CB1s]}; configuring for the clock model_{[CB2]} a sampler_{[CB2s]}; configuring for the sampler_{[CB2s]} a data input_{[CB2s]}, an enable_{[CB2s]}, a clock input_{[CB2s]} and a data output_{[CB2s]}; identifying an anchor to which the user enable_{[CB1]} is connected; and if the user enable_{[CB2]} is connected to the anchor: configuring jointly for the clock model_{[CB1]} and for the clock model_{[CB2]} a clock detector_{[E12]}; configuring for the clock detector_{[E12]} a user enable_{[E12]}, a clock input_{[E12]} and an active-edge output_{[E12]}; connecting the user enable_{[E12]} to the anchor, the user enable_{[CB1]} and the user enable_{[CB2]}; connecting the clock input_{[E12]} to the clock input_{[CB1s]}, the clock input_{[CB1]}, the clock input_{[CB2s]} and the clock input_{[CB2]}; connecting the active-edge output_{[E12]} to the enable_{[CB1s]} and to the enable_{[CB2s]}; connecting the data input_{[CB1s]} to the data input_{[CB1]}; connecting the data output_{[CB1s]} to the data output_{[CB1]}; connecting the data input_{[CB2s]} to the data input_{[CB2]}; and connecting the data output_{[CB2s]} to the data output_{[CB2]}. As shown in FIG. 20, since the clock detector_{[E12]} is used in common, C₂ represents both the user clock_{[B]} connected to the user enable_{[CB1]} and the user clock_{[B]} connected to the user enable_{[CB2]}; and MC₁ represents both the primary clock′ connected to the clock input_{[CB1]} and the primary clock′ connected to the clock input_{[CB2]}. By making two or more clock models_{[CB]} connected to a same anchor share one clock detector, it can not only obtain the same active edge as the unshared clock detector, but also greatly reduce use of clock detectors and reduce consumption of hardware resources.
iii) modifying the rest of nodes_{[B]} in the plurality of nodes being labeled as group B.

Referring to FIG. 3 again, the FIG. 3 shows a comparison diagram before and after modification. In order to better express the relationship before and after modification, the same letter used in the diagram is unchanged to indicate that the signal connected to each port before and after modification. Referring to the part a of FIG. 3, which shows structure among sequential cells of an IC design before modification, for any one register_{[FFi]} before modification, the register_{[FFi]} comprises a clock input_{[C]}, a data input_{[D]} and data output_{[Q]}, wherein the Lo is a combinational logic circuit. The clock input_{[C]} of the register_{[FFi]} is connected to the user clock_{[UCi]}, the data input_{[D]} is connected to data signal_{[Di]}, and the data output_{[Q]} outputs data signal_{[Qi]}. Referring to the part b of FIG. 3, which shows structure schematic drawing of the clock model after modification, to better express relationship among ports, D is also adopted in the part b of FIG. 3 to represent a data input_{[CA]} of a clock model_{[CA]} or a clock input_{[CB]} of a clock model_{[CB]}, Q represents a data output_{[CA]} of a clock model_{[CA]} or a data output_{[CB]} of a clock model_{[CB]}, Ev represents a user enable_{[CA]} of a clock model_{[CA]} or a user enable_{[CB]} of a clock model_{[CB]}, and the register_{[FFi]} is substituted with a clock model_{[CAi]}. The data signal_{[Di]} is connected to a data input_{[D]} of a clock model_{[CAi]}, the user clock_{[UCi]} is connected to the user enable_{[Ev]} of the clock model_{[CAi]}, a data output_{[Q]} of the clock model_{[CAi]} outputs data signal_{[Qi]}, and a clock input_{[C]} of the clock model_{[CAi]} is connected to the primary clock′. The register_{[FFi]} is substituted with a clock model_{[CAj]} by the same method, and register_{[FFp]} is substituted with a clock model_{[CAp]}, and the clock inputs of clock model_{[CAi]}, clock model_{[CAj]} and clock model_{[CBp]} are connected to corresponding clock signals_{[MC]}, respectively.

Wherein, the substituted circuit comprises a p-th clock model_{[CA]} and a g-th clock model_{[CB]}, which are series-connected, and the user enable_{[CA]} of the p-th clock model_{[CA]} and the user enable_{[CB]} of the g-th clock model_{[CB]} are connected to a same user clock. The series relationship is that the data output of the previous-level clock model is connected to the data input of the next-level clock model. The modified circuit also comprises a v-th clock model_{[CB]} and a q-th clock model_{[CB]}, which are series-connected, and the user enable_{[CB]} of the v-th clock model_{[CB]} and the user enable_{[CB]} of the q-th clock model_{[CB]} are connected to a same user clock. The v-th clock model_{[CB]} and the q-th clock model_{[CB]} also can be connected to a same primary clock′. The problem of timing sequence disorder caused by clock models_{[CB]} used in cascade structure can be solved by using two clock models_{[CA]}.
3.2) configuring a phase shaft for a primary clock′, including the steps of:
3.2.1) identifying a path on the directed graph and configuring a phase shift for a primary clock′ to which a node on the path is connected.

Preferably, an algorithm for identifying the path includes depth first search (DFS) or breadth first search (BFS). Other algorithms for identifying the path in the prior art also fall within the protection scope of the present invention.
3.2.2) numbering a total of K nodes on the path, wherein a node_{[#1]} is the root node and a node_{[#K]} is one of the leaf nodes.

It should be noted that, there is only one root node and one leaf node on a path, and the path is led by the root node and terminated by the leaf node.
i) configuring a phase shift for a primary clock′ to which a node being labeled as group B is connected, including: identifying on the path a set of nodes that are labeled as group B, which includes a node_{[#M]} and a node_{[#N]}; and letting F(x−t_{M})=F(x−t_{N}), wherein: t_{M}>t_{N}; 1≤N<M≤K; F(x−t_{M}) represents a waveform of the primary clock′ to which the node_{[#M]} is connected; ty is a phase shift; F(x−t_{N}) represents a waveform of the primary clock′ to which the node_{[#N]} is connected; and t_{N} is a phase shift.

As an example, referring to FIG. 11 again, assuming that the node_{[F4]} is a leaf node and the node_{[F2]} and the node_{[F3]} are labeled as group B, the nodes_{[F1]-[F4]} on a path in FIG. 11 are numbered sequentially, and the nodes_{[F1]-[F4]} are labeled as nodes_{[#1-4]} sequentially, then the node_{[#2]} and the node_{[#3]} satisfy: F(x−t₃)=F(x−t₂) and t₃>t₂.

Wherein, whether a clock model_{[CB]} outputs a data sample is controlled by both a user clock and a primary clock′, while whether a clock model_{[CA]} outputs a data sample is completely controlled by a user clock independently. The times for transmitting a same active edge of the user clock to different nodes in a path are in time sequence, the clock model_{[CA]} in the path directly outputs a data sample along occurring of an active edge on the user clock, while the clock model_{[CB]} in the path needs to wait for occurring of an active edge on the primary clock′ to output a data sample. For the clock model_{[CB]}, the data sample is transmitted along direction of the path, the node_{[#N]} in small number outputs the data sample firstly, and the node_{[#M]} in large number outputs the data sample later, so that the arriving time sequence of an active edge of the primary clock′ should be configured to ensure outputting sequence of the data sample, thereby ensuring normal operation of a circuit. Therefore, only when the time for outputting the data sample by the node_{[#M]} lags behind that of the node_{[#N]}, the node_{[#M]} can obtain a correct data sample. Therefore, it is necessary to configure the phase ty of the primary clock′ connected at the node_{[#M]} with the larger number in the path to be lagged behind the phase ty of the primary clock′ connected at the node_{[#N]} with the small number in the path, so as to ensure that the correct data sample can be obtained. Further, when the phase difference between the t_{M} and t_{N} is equal to or larger than the time for transmitting the data sample from the node_{[#N]} to the node_{[#M]}, a correct data sample for a sample period of the primary clock′ can be obtained by performing data sampling at the time when the data is transmitted to the node_{[#M]} or performing data sampling by waiting for a small time different.
ii) configuring a phase shift for a primary clock′, which is connected at a node being labeled as group A, including:
ii) configuring a phase shift for the primary clock′ to which a node being labeled as group A is connected, including: ii.1) identifying on the path a set of nodes that are labeled as group A, which includes a node_{[#U]}; ii.2) when 1<U<K: identifying a nearest set of nodes to the node_{[#U]} that are labeled as group B, which includes a node_{[#R]} and a node_{[#S]}, wherein: R<U<S; and letting exactly one of the two propositions be true: F(x−t_{U})=F(x−t_{R}), wherein t_{U}≥t_{R}; and F(x−t_{U})=F(x−t_{S}), wherein t_{S}≥t_{U}.

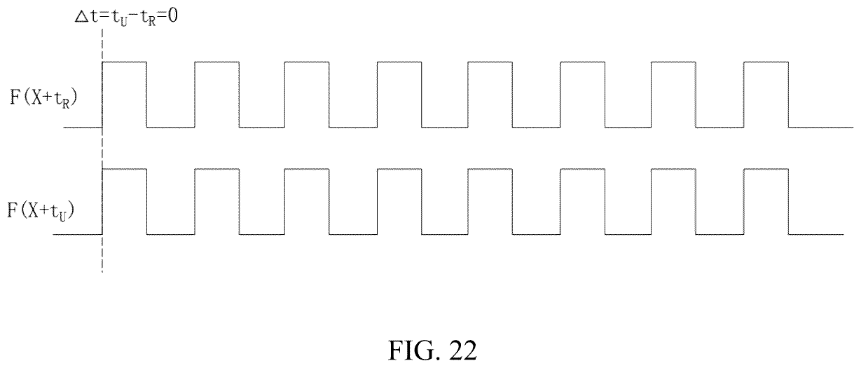

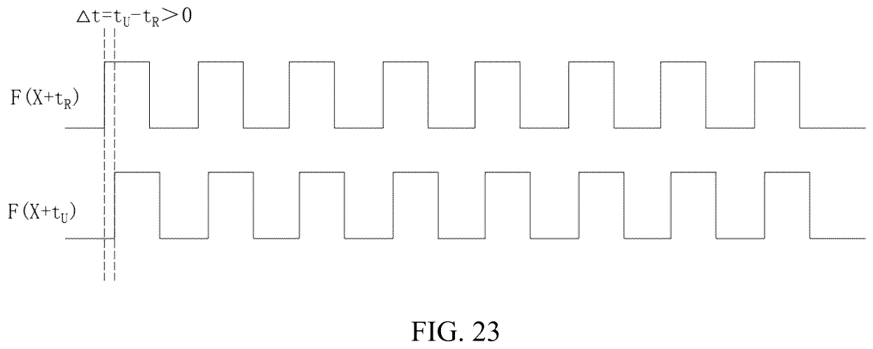

As an example, referring to FIG. 11 again, assuming that the node_{[F8]} is a leaf node, the node_{[F5]} and the node_{[7]} are labeled as group B and the node_{[F6]} is labeled as group A, the nodes_{[F1]-[F8]} in an other path in FIG. 11 are numbered sequentially, the node_{[F1]} is labeled as node_{[#1]}, the nodes_{[F5]-[F8]} are labeled as nodes_{[#2-5]} sequentially, wherein the node_{[#2]} and the node_{[#4]} are labeled as group B, satisfying: F(x−t₄)=F(x−t₂) and t₄>t₂; the node_{[#3]} is labeled as group B, satisfying: F(x−t₃)=F(x−t₂) and t₃≤t₂, or satisfying: F(x−t₃)=F(x−t₄) and t₄≤t₃.

Wherein, whether a clock model_{[CA]} outputs a data sample is not controlled by a primary clock′, so that the clock model_{[CA]} can be driven by a primary clock′ having the same phase as any clock model_{[CB]} having closest to the clock model_{[CA]}. for the node_{[#U]} and the node_{[#R]}, whether the clock model_{[CA]} corresponding to the node_{[#U]} outputs a data sample is not controlled by the primary clock′, so that the phase of the primary clock′ connected at the node_{[#U]} can be equal to that of the primary clock′ connected at the node_{[#R]} or the node_{[#S]}. As shown in FIG. 22, when the phase of the primary clock′ connected at the node_{[#U]} is equal to that of the primary clock′ connected at the node_{[#R]}, satisfying, Δt=t_{U}−t_{R}=0, but the node_{[#R]} and the node_{[#S]} are both nodes being labeled as group B, the node_{[#R]} and the node_{[#S]} also should satisfy that the phase t_{S} of the primary clock′ connected at the node_{[#S]} lags behind the phase t_{R} of the primary clock′ connected at the node_{[#R]}, that is, the phases of the node_{[#R]} and the node_{[#S]} cannot be equal, so that the phase of the primary clock′ connected at the node_{[#U]} can only be chosen to be equal to that of the primary clock′ connected at the node_{[#R]} or that of the primary clock′ connected at the node_{[#S]}. At the same time, a data sample being transmitted from the node_{[#R]} to the node_{[#U]} takes a time, so that the phase difference between t_{U} and t_{R} is equal to or larger than the time for transmitting the data sample from the node_{[#N]} to the node_{[#M]}, a correct data sample can be obtained at the node_{[#U]}. Similarly, when the phase difference between t_{U} and t_{S} is equal to or larger than the time for transmitting the data sample from the node_{[#U]} to the node_{[#R]}, a correct data sample can be obtained at the node_{[#R]}. As shown in FIG. 23, when the phase of the primary clock′ connected at the node_{[#U]} lags behind the phase of the primary clock′ connected at the node_{[#R]}, Δt=t_{U}−t_{R}>0.

Preferably, τ=t_{S}−t_{U}, satisfying: t₀<τ<T/2, or satisfying: t₀<τ<T, wherein t₀ is a minimum threshold of τ.

Preferably, t₀ is a preset offset time threshold.

Preferably, t0 is a time lag between when an active edge occurring on clock model_{[CB]} when a user clock is being inputted into a clock detector and when the active edge of the user clock is being outputted from the clock detector, so as to ensure that the offset time τ is within the time range of the active rising edge outputted by the clock detector.

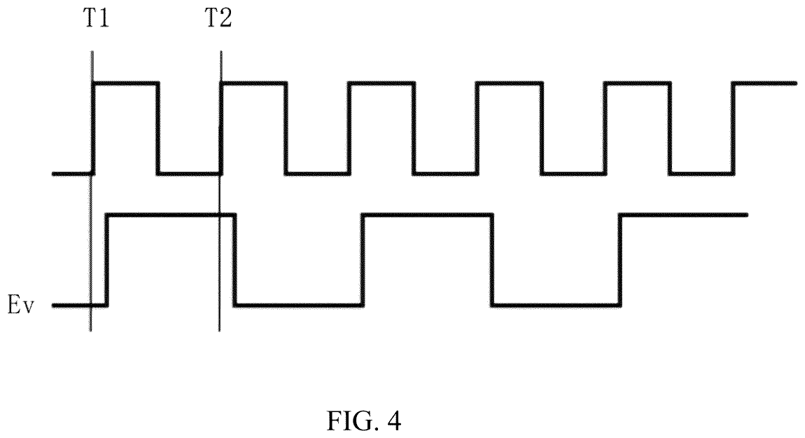

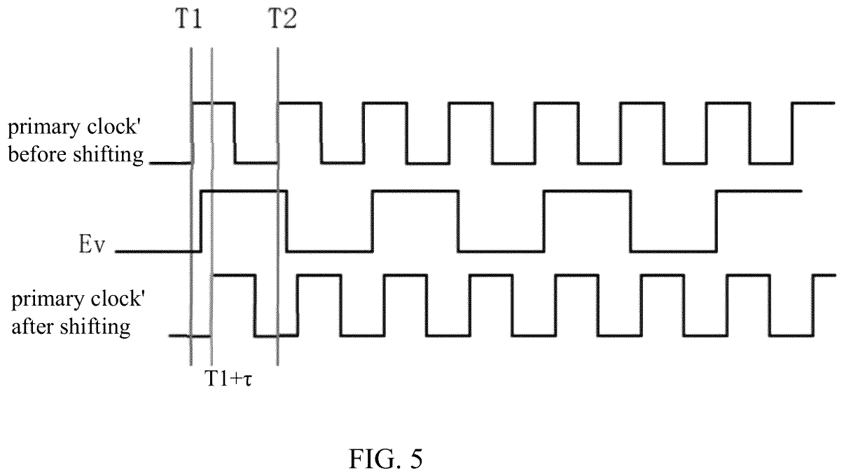

Understandably, referring to FIG. 4, the clock model_{[CB]} only performs data sampling when the active edge output_{[E1]} of a clock detector outputs and an active edge occurs on a user clock connected to the Ev and an active edge of a primary clock′ connected to a clock input occurs, that is, an active edge of the user clock is needed to be detected firstly after the user clock is connected to clock model CB, and there is a delay in a circuit before the user clock is connected to Ev, also that is, there is a small delay between the occurrence time of the active edge of the user clock connected to the Ev and the actual occurrence time of the active edge of the user clock. Therefore, when the rising edge of the primary clock′ arrives at time T1, Ev is in low logic at this time because the active edge of the user clock connected to Ev lags, so that the primary clock′ cannot sample at this rising edge at time T1; and an effective data sampling can be performed only when the rising edge of the next time T2 of the primary clock′ during the high logic of Ev arrives, so that the data sampling lags behind by one clock period of the primary clock′. Referring to FIG. 5, the shifted primary clock′ is obtained after actively shifting a primary clock′ forward by a time τ, so that the shifted primary clock′ can sample at time T1+τ. When t₀<τ<T, the sampling at time T1+τ is in the same period as the actually-desired sampling.

when U=1: identifying a nearest set of nodes to the node_{[#1]} that are labeled as group B, which includes a node_{[#S]}; and letting F(x−t_{U})=F(x−t_{S}), wherein t_{S}≥t_{U}, that is, when the root node in a path is inserted with a clock model_{[CA]}, it is necessary to satisfy that the phase of the primary clock′ at the node_{[#S]} closest to the root node is equal to or lags behind the phase of the primary clock′ at the root node, therefore, Δt=t_{S}−t_{U}≥0 should be satisfied.
ii.4) when U=K: identifying a nearest set of nodes to the node_{[#K]} that are labeled as group B, which includes node_{[#R]}; and letting F(x−t_{U})=F(x−t_{R}), wherein t_{U}≥t_{R}, that is, when the leaf node on a path is inserted with a clock model_{[CA]}, it is necessary to satisfy that the phase of the primary clock′ at the leaf node is equal to or lags behind the phase of the primary clock′ at the closest node_{[#R]}, therefore, Δt=t_{U}−t_{R}≥0 should be satisfied.

It should be noted that, the phase relationship between the clock model_{[CA]} and the clock model_{[CB]} in the path is defined in Sii.3 and Sii.4 when the root node or leaf node is inserted with a clock model_{[CA]}, ensuring a correct data sample can be obtained at a node of the plurality of nodes in the path.

Wherein, F(x−t_{R}) represents a waveform of the primary clock′ to which the node_{[#R]} is connected; t_{R} indicates the waveform's phase; F(x−t_{U}) represents a waveform of the primary clock′ to which the node_{[#U]} is connected; t_{U} indicates the waveform's phase; F(x−t_{S}) represents a waveform of the primary clock′ to which the node_{[#S]} is connected; and t_{S} indicates the waveform's phase.
3.2.3) identifying the rest of paths on the directed graph and configuring a phase shift for a primary clock′ to which a node on the other path is connected.

Preferably, a process for obtaining F(x−t_{M}) includes: obtaining a clock signal_{[Tc]}; performing X frequency division to the clock signal_{[Tc]} to obtain frequency-divided signal, which is F(x); delaying the frequency-divided signal by time ty to obtain F(x−t_{M}), and so on, obtaining waveforms of the primary clocks' at other nodes by the same method. Understandably, the clock frequency of the frequency-divided signal is 1/X times of that of the clock signal_{[Tc]}. The clock signals of the first clock substituting model and the second clock substituting model can be obtained by frequency division of the clock signal, so as to further reduce number of introduced clock domains, wherein the clock signal_{[Tc]} can be a crystal signal.

Preferably, a method for X frequency division of the clock signal_{[Tc]} includes: inputting the clock signal_{[Tc]} into a frequency divider to obtain a frequency-divided signal, wherein X is larger than 0.

Preferably, a method for delaying the frequency-divided signal by a time t includes: inputting the frequency-divided signal into a delay circuit.

The clock tree contains clock domains and data domains. X clock models_{[CA]} are contained in a clock domain, and Y hybrid clock models are contained in a data domain. The Y hybrid clock models include Y1 clock models (CA) and Y2 clock models_{[CB]}, wherein Y=Y1+Y2. The clock model_{[CA]} is a clock model having function completely equivalent to a register_{[FF]}, and the clock model_{[CB]} is a clock model having a clock delay relative to the clock model_{[CA]}. The primary clock′_{[mc2]} by which the clock model_{[CB]} is driven has a same clock period T as the primary clock′_{[mc1]} by which the clock model_{[CB]} is driven, the primary clock′_{[mc2]} has an offset time τ with respect to the primary clock′_{[me1]}, t₀<τ<T/2, and t0 is a minimum threshold for τ, wherein, a data signal from the data output of an i-th clock model_{[CA]} in a clock domain is a clock input signal of an i+1-th clock model_{[CA]}; and a data signal from the data output of a j-th hybrid clock model is a data input signal of a j+1-th clock substituting model.

It should be noted that, the number of the clock models_{[CB]} is larger than that of the clock models_{[CA]}. In actual circuits, the number of the sequential cells in a data domain is far larger than that of the sequential cells in a clock domain, so that more clock models_{[CB]} can be used after substitution, thereby converting resource consumption of the system.

For the clock models_{[CB]} in the data domain, when the data signal from the data output of the j-th sequential cell is connected to the data input of the g-th sequential cell, the j-th sequential cell and the g-th sequential cell are both substituted with clock models_{[CB]}. For two clock models_{[CB]} connected in series, the timing sequences of the two clock models_{[CB]} are exactly the same when the primary clocks' connected to the two are the same, thereby avoiding the problem of timing sequence disorder and converting resource consumption of the system.

Preferably, the method further includes:

Preferably, in a data domain, a r-th clock model_{[CB]} and a r+1-th clock model_{[CB]} are provided and in series connection, and the r+1-th clock model_{[CB]} is in series connected with a q-th clock model_{[CA]}, and the clock signal between the r+1-th clock model_{[CB]} and the q-th clock model_{[CA]} has an offset time t. A method for shifting the offset time t includes: substituting the r+1-th clock model_{[CB]} with a clock model_{[CA]} such that the offset time t is shifted between the r+1-th clock model_{[CB]} and the q-th clock model_{[CA]}. By shifting offset time through adjusting types of clock substituting models, the maximum clock frequency of the system is further increased, thereby improving performances of the system.

It should be noted that: all clock models_{[CA]} in the clock domain are within same clock domain, and the less the clock domain is introduced, the less resources of the BUFG are required, so as to further save resource consumption of the system. The whole system can simultaneously started-up and paused by controlling one primary clock′.

It should be noted that: the primary clocks' that drive all clock models_{[CB]} in group B are the same.
S4) converting the IC design into a modified design;
S5) implementing the modified design on the FPGA; and
S6) validating the IC design with the FPGA on which the modified design is implemented.

In conclusion, an embodiment of the present invention provides a method for emulating an IC design with an FPGA, comprising the steps of: extracting a directed graph by identifying logic paths of the sequential cells in an IC design, and substituting a clock model_{[CA]} or a clock model_{[CB]} for a sequential cell corresponding to a node in the directed graph; adding a user enable to an external port of the clock model_{[CA]} or the clock model_{[CB]} compared to the port of a sequential cell in the IC design, through cooperation of a user clock to which a clock model_{[CA]} or a user enable of a clock model_{[CA]} is connected and a primary clock′ to which a clock input is connected, a clock model_{[CA]} reproducing the function of the sequential cell in the IC design by controlling outputting time of a data sample, and the clock model_{[CB]} reproducing the function of the sequential cell in the IC design by controlling data sampling time; and configuring phase shifts for primary clocks' by which the clock model_{[CA]} and the clock model_{[CB]} are driven to ensure normal operation of a circuit. The primary clocks' are directly connected to the clock inputs of the clock model_{[CA]} and the clock model_{[CB]} and contain no glitch, the user clock is connected to user enables of the clock model_{[CA]} and the clock model_{[CB]}, but the user enable is non-sensitive to glitch-containing user clock, so that the invention can solve the technical problem of sampling error due to presence of the user clock while ensuring the function of the original sequential cells.

Compared with example 2 and example 3, example 1 has the effect that: the problems of large hardware resource consumption due to all using of clock models_{[CA]} and large number of clock domains due to all using of clock models_{[CB]} are balanced.

### Example 2

A method for emulating an IC design with an FPGA is provided in example 2. The method comprises the steps of:
S1) identifying in the IC design: a primary clock, a subcircuit, a plurality of generated clocks and a plurality of sequential cells, wherein the plurality of generated clocks are derived from the primary clock after being processed by the subcircuit, and a user clock being connected to one of the plurality of sequential cells is the primary clock or one of the plurality of generated clocks.
S2) converting the IC design into a directed graph, including: 2.1) converting the plurality of sequential cells to a plurality of nodes, and 2.2) constructing the directed graph by connecting the plurality of nodes.

Wherein, S2.1 for converting the plurality of sequential cells to a plurality of nodes includes: converting a sequential cell in the plurality of sequential cells to a node, including: identifying a user clock by which the sequential cell is driven; identifying a plurality of nodes on the sequential cells and constructing the directed graph by connecting the plurality of nodes; wherein identifying a plurality of nodes on the sequential cells includes: a data input; a user-clock input and a data output, and the user clock is connected to the user-clock input; converting the sequential cell into a node, including: defining a logic path having a pair of endpoints, wherein: the user-clock input constitutes one of the pair of endpoints; and the data output constitutes the other one of the pair of endpoints; defining a node on the logic path between the pair of endpoints, and defining another logic path and defining a node on the other logic path between its pair of endpoints; and converting the rest of the plurality of sequential cells to nodes.
S3) configuring the plurality of nodes on the directed graph which includes exactly a root node and a plurality of leaf nodes, including: 3.1) inserting a clock model_{[CA]} at a node on the directed graph, and 3.2) configuring a phase shift for the primary clock′.

Wherein, S3.1 includes: 3.1.1) labeling a plurality of nodes on the directed graph all as group A; 3.1.2) modifying the nodes that are labeled as group A.

Wherein, S3.1.2 further includes i) configuring the clock model_{[CA]}, which includes a data input_{[CA]}, a data output_{[CA]}, a user enable_{[CA]} and a clock input_{[CA]}; ii) modifying a node_{[A]} in the plurality of nodes being labeled as group A; and iii) modifying the rest of nodes_{[A]} in the plurality of nodes being labeled as group A.

Wherein, S3.1.2.ii includes: ii.1) identifying a logic path by which the node_{[A]} is defined in view of S2, wherein: an endpoint of the logic path is located at a user-clock input_{[A]}; the other endpoint of the logic path is located at a data output_{[A]}; and a user clock_{[A]} is connected to the user-clock input_{[A]}.
ii.2) inserting the clock model_{[CA]} at the node_{[A]}, including: connecting the data input_{[CA]} to what was connected to the data input_{[A]}; connecting the data output_{[CA]} to what was connected to the data output_{[A]}; connecting the user enable_{[CA]} to what was connected to the user-clock input_{[A]}; and connecting the clock input_{[CA]} to a primary clock′ which is equal to or greater than the primary clock in frequencies.
ii.3) configuring the clock model_{[CA]}, including: sampling a signal from the data input_{[CA]} at an active edge of the primary clock′ to obtain a data sample for a period of the primary clock′ led by the active edge; when an N-th active edge is occurring on the user clock_{[A]}: obtaining a data sample_{[N]} for a contemporary period of the primary clock′; and outputting to the data output_{[CA]} the data sample_{[N]} until an N+1-th active edge occurs on the user clock_{[A]}; and when the N+1-th active edge is occurring on the user clock_{[A]}: obtaining a data sample_{[N+1]} for a contemporary period of the primary clock′; and outputting to the data output_{[CA]} the data sample_{[N+1]} until an N+2-th active edge occurs on the user clock_{[A]}.

Wherein, S3.2 includes:
3.2.1) identifying a path on the directed graph and configuring a phase shift for a primary clock′ to which a node on the path is connected.
3.2.2) numbering on the path a total of K nodes, wherein the total of K nodes include: a node_{[#1]}, a node_{[#H]}, a node_{[#U]} and a node_{[#K]}, wherein the node_{[#1]} is the root node, the node_{[#K]} is one of the leaf nodes; and 1K≥H≤U≤K.
3.2.3) letting F(x−t_{U})=F(x−t_{H}) and t_{U}≥t_{H}, wherein: F(x−t_{U}) represents a waveform for a primary clock′ to which the node_{[#U]} is connected, and t_{U} indicates a phase shift; and F(x−t_{H}) represents a waveform for a primary clock′ to which the node_{[#H]} is connected, and t_{H} indicates a phase shift.
3.2.4) identifying another path on the directed graph and configuring a phase shift for a primary clock′ to which a node on the other path is connected.

Preferably, S3.1 further includes: configuring for the clock model_{[CA]} a clock detector_{[E1]} and a sampler_{[CAs]}; configuring for the clock detector_{[E1]} a user enable_{[E1]}, a clock input_{[E1]} and an active-edge output_{[E1]}; configuring for the sampler_{[CAs]} a data input_{[CAs]}, an enable_{[CAs]}, a clock input_{[CAs]} and a data output_{[CAs]}; connecting the user enable_{[E1]} to the user enable_{[CA]}; connecting the clock input_{[E1]} and the clock input_{[CAs]} to the clock input_{[CA]}; connecting the active-edge output_{[E1]} to the enable_{[CAs]}; connecting the data input_{[CAs]} to the data input_{[CA]}; and connecting the data output_{[CAs]} to the data output_{[CA]}.

Preferably, wherein, S3.1 further includes: configuring for the sampler_{[CAs]} a first state holder_{[Re1]}, a second state holder_{[Re2]} and a multiplexer_{[MUX1]}; configuring for the first state holder_{[Re1]} a clock input_{[Re1]}, a data input_{[Re1]} and a data output_{[Re1]}; configuring for the second state holder_{[Re2]} a clock input_{[Re2]}, a data input_{[Re2]} and a data output_{[Re2]}; configuring for the multiplexer_{[MUX1]} a first data input_{[MUX1]}, a second data input_{[MUX1]}, a signal selection_{[MUX1]} and a data output_{[MUX1]}; connecting the data input_{[Re1]} to the data input_{[CAs]}; connecting the data output_{[MUX1]} to the data output_{[CAs]}; connecting the clock input_{[Re1]} and the clock input_{[Re2]} to the clock input_{[CAs]}; connecting the data output_{[Re1]} to the first data input_{[MUX1]}; connecting the data input_{[Re2]} to the data output_{[MUX1]}; connecting the data output_{[Re2]} to the second data input_{[MUX1]}; and connecting the enable_{[CAs]} to the signal selection_{[MUX1]}.

Preferably, wherein, in S1, the plurality of sequential cells include: a sequential cell_{[A1]} and a sequential cell[2]; in S2, on the directed graph: the sequential cell_{[A1]} is converted to a node_{[A1]}; and the sequential cell_{[A2]} is converted to a node_{[A2}; in S3.1.1, the node_{[A1]} and the node_{[A2]} are both labeled as group A; in S3.1.2: a clock model_{[CA1]} is inserted at the node_{[A1]}; and the clock model_{[CA1]} is configured to include a data input_{[CA1]}, a data output_{[CA1]}, a user enable_{[CA1]} and a clock input_{[CA1]}; a clock model_{[CA2]} is inserted at the node_{[A2]}; and the clock model_{[CA2]} is configured to include a data input_{[CA2]}, a data output_{[CA2]}, a user enable_{[CA2]} and a clock input_{[CA2]}; S3.1 further includes: configuring for the clock model_{[CA1]} a sampler_{[CA1s]}; configuring for the sampler_{[CAs1]} a data input_{[CA1s]}, an enable_{[CA1s]}, a clock input_{[CA1s]} and a data output_{[CA1s]}; configuring for the clock model_{[CA2]} a sampler_{[CA2s]}; configuring for the sampler_{[CA2s]} a data input_{[CA2s]}, an enable_{[CA2s]}, a clock input_{[CA2s]} and a data output_{[CA2s]}; identifying an anchor to which the user enable_{[CA1]} is connected; and if the user enable_{[CA2]} is connected to the anchor: configuring jointly for the clock model_{[CA1]} and for the clock model_{[CA2]} a clock detector_{[E12]}; configuring for the clock detector_{[E12]} a user enable_{[E12]}, a clock input_{[E12]} and an active-edge output_{[E12]}; connecting the user enable_{[E12]} to the anchor, the user enable_{[CA1]} and the user enable_{[CA2]}; connecting the clock input_{[E12]} to the clock input_{[CA1s]}, the clock input_{[CA1]}, the clock input_{[CA2s]} and the clock input_{[CA2]}; connecting the active-edge output_{[E12]} to the enable_{[CA1s]} and to the enable_{[CA2s]}; connecting the data input_{[CA1s]} to the data input_{[CA1]}; connecting the data output_{[CA1s]} to the data output_{[CA1]}; connecting the data input_{[CA2s]} to the data input_{[CA2]}; and connecting the data output_{[CA2s]} to the data output_{[CA2]}.

The example 2 has the benefits that: the phase shifts of all clock models_{[CA]} can be the same, when the phase shifts are the same, all clock models_{[CA]} are located in a same clock domain, so as to not only save BUFG hardware sources, but also achieve the purpose of simultaneously starting-up or pausing a circuit.

### Example 3

A method for emulating an IC design with an FPGA is provided in example 3. The method comprises the steps of:
S1) identifying in the IC design: a primary clock, a subcircuit, a plurality of generated clocks and a plurality of sequential cells, wherein the plurality of generated clocks are derived from the primary clock after being processed by the subcircuit, and a user clock being connected to one of the plurality of sequential cells is the primary clock or one of the plurality of generated clocks.
S2) converting the IC design into a directed graph, including: 2.1) converting the plurality of sequential cells to a plurality of nodes, and 2.2) constructing the directed graph by connecting the plurality of nodes.

Wherein, S2.1 for converting the plurality of sequential cells to a plurality of nodes includes: converting a sequential cell in the plurality of sequential cells to a node, including: identifying a user clock by which the sequential cell is driven; identifying a plurality of nodes on the sequential cells and constructing the directed graph by connecting the plurality of nodes; wherein identifying a plurality of nodes on the sequential cells includes: a data input; a user-clock input and a data output, and the user clock is connected to the user-clock input; converting the sequential cell into a node, including: defining a logic path having a pair of endpoints, wherein: the user-clock input constitutes one of the pair of endpoints; and the data output constitutes the other one of the pair of endpoints; defining a node on the logic path between the pair of endpoints; and defining another logic path and defining a node on the other logic path between its pair of endpoints; and converting the rest of the plurality of sequential cells to nodes.
S3) configuring the plurality of nodes on the directed graph which includes exactly a root node and a plurality of leaf nodes, including: 3.1) inserting a clock model_{[CB]} at a node on the directed graph, and 3.2) configuring a phase shift for a primary clock′.

Wherein, S3.1 includes: 3.1.1) labeling a plurality of nodes on the directed graph all as group B; 3.1.2) modifying the nodes that are labeled as group B.

Wherein, S3.1.2 includes i) configuring the clock model_{[CB]}, which includes a data input_{[CB]}, a data output_{[CB]}, a user enable_{[CB]} and a clock input_{[CB]}; ii) modifying a node_{[B]} in the plurality of nodes being labeled as group B; and iii) modifying the rest of nodes_{[B]} in the plurality of nodes being labeled as group B.

Wherein, S3.1.2.ii includes:
ii.1) identifying a logic path by which the node_{[B]} is defined in view of S2, wherein: an endpoint of the logic path is located at a user-clock input_{[B]}; the other endpoint of the logic path is located at a data output_{[B]}; and the user clock_{[B]} is connected to the user-clock input_{[B]}.
ii.2) inserting a clock model_{[CB]} at the node_{[B]}, including: connecting the data input_{[CB]} to what was connected to the data input_{[B]}; connecting the data output_{[CB]} to what was connected to the data output_{[B]}; connecting the user enable_{[B]} to what was connected to the user-clock input_{[B]}; and connecting the clock input_{[CB]} to a primary clock′ which is equal to or greater than the primary clock in frequencies.
ii.3) configuring the clock model_{[CB]}, including: when an active edge is occurring on the user clock_{[B]} and when an active edge is occurring on the primary clock′: sampling a signal from the data input_{[CB]} to obtain a data sample for a period of the primary clock′ led by the active edge; and; and when no active edge occurs on the user clock_{[B]} or no active edge occurs on the primary clock′: sampling nothing from the data input_{[CB]}; and outputting nothing to the data output_{[CB]}.

Wherein, S3.2 includes: 3.2.1) identifying a path on the directed graph and configuring a phase shift for a primary clock′ to which a node on the path is connected; 3.2.2) numbering a total of K nodes on the path, wherein the total of K nodes include: a node_{[#1]}, a node_{[#N]}, a node_{[#M]} and a node_{[#K]}, wherein the node_{[#1]} is the root node, and the node_{[#K]} is one of the leaf nodes, wherein: 1≤N≤M≤K; 3.2.3) letting F(x−t_{M})=F(x−t_{N}) [symbol] t_{M}>t_{N}, wherein: F(x−t_{M}) is represents waveform for a primary clock′ connected to the node_{[#M]}, and ty indicates a phase shift; and F(x−t_{N}) represents a waveform of the primary clock′ to which the node_{[#N]} is connected, and t_{N} indicates a phase shift; and 3.2.4) identifying an other path on the directed graph and configuring a phase shift for a primary clock′ to which a node on the other path is connected.

Preferably, wherein, S3.1 further includes: configuring for the clock model_{[CB]} a clock detector_{[E2]} and a sampler_{[CBs]}; configuring for the clock detector_{[E2]} a user enable_{[E2]}, a clock input_{[E2]} and an active-edge output_{[E2]}; configuring for the sampler_{[CBs]} a clock input_{[CBs]}, an enable_{[CBs]}, a data input_{[CBs]} and a data output_{[CBs]}; connecting the data input_{[CBs]} to the data input_{[CB]}; connecting the data output_{[CBs]} to the data output_{[CB]}; connecting the clock input_{[E2]} and the clock input_{[CBs]} to the clock input_{[CB]}; connecting the user enable_{[E2]} to the user enable_{[CB]}; and connecting the active-edge output_{[E2]} to the enable_{[CBs]}.

Preferably, the sampler_{[CBs]} is configured to be a register having an enable.

Preferably, wherein, in S1, the plurality of sequential cells include: a sequential cell_{[B1]} and a sequential cell_{[B2]}; in S2, on the directed graph: the sequential cell_{[B1]} is converted to a node_{[B1]}, and the sequential cell_{[B2]} is converted to a node_{[B2]}; in S3.1.1, the node_{[B1]} and the node_{[B2]} are both labeled as group B; in S3.1.2: a clock model_{[CB1]} is inserted at the node_{[B1]}; the clock model_{[CB1]} is configured to include a data input_{[CB1]}, a data output_{[CB1]}, a user enable_{[CB1]} and a clock input_{[CB1]}; a clock model_{[CB2]} is inserted at the node_{[B2]}; and the clock model_{[CB2]} is configured to include a data input_{[CB2]}, a data output_{[CB2]}, a user enable_{[CB2]} and a clock input_{[CB2]}; S3.1 further includes: configuring for the clock model_{[CB1]} a sampler_{[CB1s]}; configuring for the sampler_{[CB1s]} a data input_{[CB1s]}, an enable_{[CB1s]}, a clock input_{[CB1s]} and a data output_{[CB1s]}; configuring for the clock model_{[CB2s]} a sampler_{[CB2s]}; configuring for the sampler_{[CB2s]} a data input_{[CB2s]}, an enable_{[CB2s]}, a clock input_{[CB2s]} and a data output_{[CB2s]}; identifying an anchor to which the user enable_{[CB1]} is connected; and if the user enable_{[CB2]} is connected to the anchor: configuring jointly for the clock model_{[CB1]} and for the clock model_{[CB2]} a clock detector_{[E12]}; configuring for the clock detector_{[E12]} a user enable_{[E12]}, a clock input_{[E12]} and an active-edge output_{[E12]}; connecting the user enable_{[E12]} to the anchor, the user enable_{[CB1]} and the user enable_{[CB2]}; connecting the clock input_{[E12]} to the clock input_{[CB1s]}, the clock input_{[CB1]}, the clock input_{[CB2s]} and the clock input_{[CB2]}; connecting the active-edge output_{[E12]} to the enable_{[CB1s]} and to the enable_{[CB2s]}; connecting the data input_{[CB1s]} to the data input_{[CB1]}; connecting the data output_{[CB1s]} to the data output_{[CB1]}; connecting the data input_{[CB2s]} to the data input_{[CB2]}; and connecting the data output_{[CB2s]} to the data output_{[CB2]}.

Example 3 has the benefits that: since the clock model_{[CB]} has simple structure, compared with the example 1 and the example 2, the example 3 can greatly reduce consumption of FPGA hardware resources.

Based on the same inventive conception as the methods in embodiments, an embodiment of the present invention also provides a system for emulating an IC design with an FPGA, comprising a processor and a computer-readable storage medium in communication with the processor, wherein: the system implements the method for emulating an IC design with an FPGA and provided in any one embodiment aforementioned when the processor executes a program in the computer-readable storage medium.

Wherein, the processor can comprise one or more processing cores, such as 4-core processor, 12-core processor, etc. The processor can realize processing by using at least one hardware form of a digital signal processing (DSP), a field programmable gate array (FPGA) and a programmable logic array (PLA). The processor can also include a host processor and a coprocessor. The host processor is a processor used to process the data in wake state, also known as CPU. The coprocessor is a low-power processor used to process data in standby mode. In some embodiments, the processor may be integrated with a graphics processing unit (GPU), which is responsible for rendering and painting the content required by the display. In some embodiments, the processor may also include an artificial intelligence (AI) processor for processing computational operations concerning machine learning.

Wherein, the computer-readable storage medium is a memory device in a computer device, and is used to store information such as computer readable instructions, data structures, program modules or other data. Understandably, the storage medium herein can include a built-in storage medium in the computer device, and, of course, can include an extended storage medium supported by a computer device. The storage medium provides a storage space, in which one or more computer instructions loadable and executable by the processor are also stored. These computer instructions may be one or more computer programs (including program code). It should be noted that the storage medium herein can be a high-speed RAM memory, and also can be a non-volatile memory. For example, the memory medium comprises RAM, ROM, erasable programmable read-only memory (EPROM), electrically erasable programmable read-only memory (EEPROM), flash memory or other solid memories, CD-ROM, digital video disc (DVD) or other optical memories, tape cartridge, tape, memories or other magnetic memory device, etc. Of course, the skilled in the field know that computer storage media are not limited to the aforementioned.

Based on the same inventive conception as the methods in embodiments, an embodiment of the present invention also provides a non-transitory computer-readable storage medium in which at least one instruction or at least one program is stored, wherein: the at least one instruction or the at least one program is loadable and executable by a processor to implement the method for emulating an IC design with an FPGA and provided in any one embodiment aforementioned, wherein the method for emulating an IC design with an FPGA is described in detail in the method embodiments, and here detailed description is avoided.

What is claimed is:

1. A method for emulating an IC design with an FPGA, comprising the steps of:
S1) identifying in the IC design:
a primary clock;
a subcircuit;
a plurality of generated clocks, which are derived from the primary clock after being processed by the subcircuit; and
a plurality of sequential cells, wherein a user clock being connected to one of the plurality of sequential cells is the primary clock or one of the plurality of generated clocks;
S2) converting the IC design into a directed graph, including:
2.1) converting the plurality of sequential cells to a plurality of nodes, including:
2.1.1) converting a sequential cell in the plurality of sequential cells to a node, including:
i) identifying on the sequential cell:
a user clock by which the sequential cell is driven;
a data input;
a user-clock input to which the user clock is connected; and
a data output; and
ii) converting the sequential cell to a node, including:
defining a logic path having a pair of endpoints, wherein: the user-clock input constitutes one of the pair of endpoints; and the data output constitutes the other one of the pair of endpoints;
defining a node on the logic path between the pair of endpoints; and
defining an other logic path and defining a node on the other logic path between its pair of endpoints; and
2.1.2) converting the rest of the plurality of sequential cells to nodes; and
2.2) constructing the directed graph by connecting the plurality of nodes; and
S3) configuring the plurality of nodes on the directed graph which includes exactly one root node and a plurality of leaf nodes, including:
3.1) inserting a clock model at a node on the directed graph, including:
3.1.1) labeling on the directed graph at least a node as group A and at least an other node as group B;
3.1.2) modifying the nodes that are labeled as group A, including:
i) configuring a clock model_{[CA]}, which includes a data input_{[CA]}, a data output_{[CA]}, a user enable_{[CA]} and a clock input_{[CA]};
ii) modifying a node_{[A]} in the plurality of nodes being labeled as group A, including:
ii.1) identifying a logic path by which the node_{[A]} is defined in view of S2, wherein:
an endpoint of the logic path is located at a user-clock input_{[A]};
the other endpoint of the logic path is located at a data output_{[A]}; and
a user clock_{[A]} is connected to the user-clock input_{[A]};
ii.2) inserting the clock model_{[CA]} at the node_{[A]}, including:
connecting the data input_{[CA]} to what was connected to the data input_{[A]};
connecting the data output_{[CA]} to what was connected to the data output_{[A]};
connecting the user enable_{[CA]} to what was connected to the user-clock input_{[A]}; and
connecting the clock input_{[CA]} to a primary clock′ which is equal to or greater than the primary clock in frequencies; and
ii.3) configuring the clock model_{[CA]}, including:
sampling a signal from the data input_{[CA]} at an active edge of the primary clock′ to obtain a data sample for a period of the primary clock′ led by the active edge;
when an N-th active edge is occurring on the user clock_{[A]}:
obtaining a data sample_{[N]} for a contemporary period of the primary clock′; and
outputting to the data output_{[CA]} the data sample_{[N]} until an N+1-th active edge occurs on the user clock_{[A]}; and
when the N+1-th active edge is occurring on the user clock_{[A]}:
obtaining a data sample_{[N+1]} for a contemporary period of the primary clock′; and
outputting to the data output_{[CA]} the data sample_{[N+1]} until an N+2-th active edge occurs on the user clock_{[A]}; and
iii) modifying the rest of nodes_{[A]} in the plurality of nodes being labeled as group A; and
3.1.3) modifying the nodes that are labeled as group B, including:
i) configuring a clock model_{[CB]}, which includes a data input_{[CB]}, a data output_{[CB]}, a user enable_{[CB]} and a clock input_{[CB]};
ii) modifying a node_{[B]} in the plurality of nodes being labeled as group B, including:
ii.1) identifying a logic path by which the node_{[B]} is defined in view of S2, wherein:
an endpoint of the logic path is located at a user-clock input_{[B]};
the other endpoint of the logic path is located at a data output_{[B]}; and
a user clock_{[B]} is connected to the user-clock input_{[B]};
ii.2) inserting the clock model_{[CB]} at the node_{[B]}, including:
connecting the data input_{[CB]} to what was connected to the data input_{[B]};
connecting the data output_{[CB]} to what was connected to the data output_{[B]};
connecting the user enable_{[CB]} to what was connected to the user-clock input_{[B]}; and
connecting the clock input_{[CB]} to a primary clock′ which is equal to or greater than the primary clock in frequencies; and
ii.3) configuring the clock model_{[CB]}, including:
when an active edge is occurring on the user clock_{[B]} and when an active edge is occurring on the primary clock′:
sampling a signal from the data input_{[CB]} to obtain a data sample for a period of the primary clock′ led by the active edge; and
outputting the data sample to the data output_{[CB]}; and
when no active edge occurs on the user clock_{[B]} or no active edge occurs on the primary clock′:
sampling nothing from the data input_{[CB]}; and
outputting nothing to the data output_{[CB]}; and
iii) modifying the rest of nodes_{[B]} in the plurality of nodes being labeled as group B; and
3.2) configuring a phase shift for the primary clock′, including:
3.2.1) identifying a path on the directed graph and configuring a phase shift for the primary clock′ to which a node on the path is connected;
3.2.2) numbering a total of K nodes on the path, wherein a node_{[#1]} is the root node and a node_{[#K]} is one of the leaf nodes;
i) configuring a phase shift for the primary clock′ to which a node being labeled as group B is connected, including:
i.1) identifying on the path a set of nodes that are labeled as group B, which includes a node_{[#M]} and a node_{[#N]}; and
i.2) letting F(x−t_{M})=F(x−t_{N}), wherein:
t_{M}>t_{N};
1≤N<M≤K;
F(x−t_{M}) represents a waveform of the primary clock′ to which the node_{[#M]} is connected;
t_{M} is a phase shift;
F(x−t_{N}) represents a waveform of the primary clock′ to which the node_{[#N]} is connected; and
t_{N} is a phase shift;
ii) configuring a phase shift for the primary clock′ to which a node being labeled as group A is connected, including:
ii.1) identifying on the path a set of nodes that are labeled as group A, which includes a node_{[#U]};
ii.2) when 1<U<K:
identifying a nearest set of nodes to the node_{[#U]} that are labeled as group B, which includes a node_{[#R]} and a node_{[#S]}, wherein: R<U<S; and
letting exactly one of the two propositions be true:
F(x−t_{U})=F(x−t_{R}), wherein t_{U}≥t_{R}; and
F(x−t_{U})=F(x−t_{S}), wherein t_{S}≥t_{U};
ii.3) when U=1:
identifying a nearest set of nodes to the node_{[#1]} that are labeled as group B, which includes a node_{[#S]}; and
letting F(x−t_{U})=F(x−t_{S}), wherein t_{S}≥t_{U}; and
ii.4) when U=K:
identifying a nearest set of nodes to the node_{[#K]} that are labeled as group B, which includes node_{[#R]}; and
letting F(x−t_{U})=F(x−t_{R}), wherein t_{U}≥t_{R},
wherein:
F(x−t_{R}) represents a waveform of the primary clock′ to which the node_{[#R]} is connected;
t_{R} indicates the waveform's phase;
F(x−t_{U}) represents a waveform of the primary clock′ to which the node_{[#U]} is connected;
t_{U} indicates the waveform's phase;
F(x−t_{S}) represents a waveform of the primary clock′ to which the node_{[#S]} is connected; and
t_{S} indicates the waveform's phase; and
3.2.3) identifying an other path on the directed graph and configuring a phase shift for the primary clock′ to which a node on the other path is connected.

2. The method in claim 1, wherein S3.1.2 further includes:
configuring for the clock model_{[CA]} a clock detector_{[E1]} and a sampler_{[CAs]};
configuring for the clock detector_{[E1]} a user enable_{[E1]}, a clock input_{[E1]} and an active-edge output_{[E1]};
configuring for the sampler_{[CAs]} a data input_{[CAs]}, an enable_{[CAs]}, a clock input_{[CAs]} and a data output_{[CAs]};
connecting the user enable_{[E1]} to the user enable_{[CA]};
connecting the clock input_{[E1]} and the clock input_{[CAs]} to the clock input_{[CA]};
connecting the active-edge output_{[E1]} to the enable_{[CAs]};
connecting the data input_{[CAs]} to the data input_{[CA]}; and
connecting the data output_{[CAs]} to the data output_{[CA]}.

3. The method in claim 2, wherein S3.1.2 further includes:
configuring for the sampler_{[CAs]} a first state holder_{[Re1]}, a second state holder_{[Re2]} and a multiplexer_{[MUX1]};
configuring for the first state holder_{[Re1]} a clock input_{[Re1]}, a data input_{[Re1]} and a data output_{[Re1]};
configuring for the second state holder_{[Re2]} a clock input_{[Re2]}, a data input_{[Re2]} and a data output_{[Re2]};
configuring for the multiplexer_{[MUX1]} a first data input_{[MUX1]}, a second data input_{[MUX1]}, a signal selection_{[MUX1]} and a data output_{[MUX1]};
connecting the data input_{[Re1]} to the data input_{[CAs]};
connecting the data output_{[MUX1]} to the data output_{[CAs]};
connecting the clock input_{[Re1]} and the clock input_{[Re2]} to the clock input_{[CAs]};
connecting the data output_{[Re1]} to the first data input_{[MUX1]};
connecting the data input_{[Re2]} to the data output_{[MUX1]};
connecting the data output_{[Re2]} to the second data input_{[MUX1]}; and
connecting the enable_{[CAs]} to the signal selection_{[MUX1]}.

4. The method in claim 1, wherein:
S2.1 further includes identifying on the sequential cell:
a data input;
a user-clock input;
a data output; and
an enable; and
S3.1.2 further includes:
configuring for the clock model_{[CA]} a data input_{[CA]}, a data output_{[CA]}, a user enable_{[CA]}, a clock input_{[CA]} and an enable_{[CA]};
configuring for the clock model_{[CA]} a clock detector_{[E1]}, a first state holder_{[Re1]}, a second state holder_{[Re2]}, a multiplexer_{[MUX1]} and a multiplexer_{[MUX2]};
configuring for the clock detector_{[E1]} a user enable_{[E1]}, a clock input_{[E1]} and an active-edge output_{[E1]};
configuring for the first state holder_{[Re1]} a clock input_{[Re1]}, a data input_{[Re1]} and a data output_{[Re1]};
configuring for the second state holder_{[Re2]} a clock input_{[Re2]}, a data input_{[Re2]} and a data output_{[Re2]};
configuring for the multiplexer_{[MUX1]} a first data input_{[MUX1]}, a second data input_{[MUX1]}, a signal selection_{[MUX1]} and a data output_{[MUX1]};
configuring for the multiplexer_{[MUX2]} a first data input_{[MUX2]}, a second data input_{[MUX2]}, a signal selection_{[MUX2]} and a data output_{[MUX2]};
connecting the second data input_{[MUX2]} to the data input_{[CA]};
connecting the data output_{[MUX1]} to the data output_{[CA]}, the data input_{[Re2]} and the first data input_{[MUX2]};
connecting the clock input_{[Re1]}, the clock input_{[Re2]} and the clock input_{[E1]} to the clock input_{[CA]};
connecting the user enable_{[E1]} to the user enable_{[CA]};
connecting the active-edge output_{[E1]} to the signal selection_{[MUX1]};
connecting the data output_{[Re2]} to the second data input_{[MUX1]};
connecting the enable_{[CA]} to signal selection_{[MUX2]};
connecting the data output_{[MUX2]} to data input_{[Re1]}; and
connecting the data output_{[Re1]} to first data input_{[MUX1]}.

5. The method in claim 4, wherein:
the first state holder_{[Re1]} is configured to be a register or a latch; and
the second state holder_{[Re2]} is configured to be a register or a latch.

6. The method in claim 1, wherein S3.1.3 further includes:
configuring for the clock model_{[CB]} a clock detector_{[E2]} and a sampler_{[CBs]};
configuring for the clock detector_{[E2]} a user enable_{[E2]}, a clock input_{[E2]} and an active-edge output_{[E2]};
configuring for the sampler_{[CBs]} a clock input_{[CBs]}, an enable_{[CBs]}, a data input_{[CBs]} and a data output_{[CBs]};
connecting the data input_{[CBs]} to the data input_{[CB]};
connecting the data output_{[CBs]} to the data output_{[CB]};
connecting the clock input_{[E2]} and the clock input_{[CBs]} to the clock input_{[CB]};
connecting the user enable_{[E2]} to the user enable_{[CB]}; and
connecting the active-edge output_{[E2]} to the enable_{[CBs]}.

7. The method in claim 6, wherein the sampler_{[CBs]} is configured to be a register having an enable.

8. The method in claim 6, wherein S3.1.3 further includes:
configuring for the sampler_{[CBs]} a fourth state holder_{[Re4]} and a multiplexer_{[MUX3]};
configuring for the fourth state holder_{[Re4]} a clock input_{[Re4]}, a data input_{[Re4]} and a data output_{[Re4]};
configuring for the multiplexer_{[MUX3]} a first data input_{[MUX3]}, a second data input_{[MUX3]}, a signal selection_{[MUX3]} and a data output_{[MUX3]};
connecting the first data input_{[MUX3]} to the data input_{[CBs]};
connecting the data output_{[Re4]} to the second data input_{[MUX3]} and the data output_{[CBs]};
connecting the clock input_{[Re4]} to the clock input_{[CBs]};
connecting the signal selection_{[MUX3]} to the enable_{[CBs]}; and
connecting the data output_{[MUX3]} to the data input_{[Re4]}.

9. The method in claim 1, wherein S3.1.3 further includes:
configuring for the clock model_{[CB]} a third state holder_{[Re3]}, a fourth state holder_{[Re4]} and a lookup table_{[LUT1]};
configuring for the third state holder_{[Re3]} a clock input_{[Re3]}, a data input_{[Re3]} and a data output_{[Re3]};
configuring for the fourth state holder_{[Re4]} a clock input_{[Re4]}, a data input_{[Re4]} and a data output_{[Re4]};
configuring for the lookup table_{[LUT1]} a first data input_{[LUT1]}, a second data input_{[LUT1]}, a third data input_{[LUT1]}, a fourth data input_{[LUT1]} and a data output_{[LUT1]};
connecting the second data input_{[LUT1]} to the data input_{[CB]};
connecting the data output_{[Re4]} to the first data input_{[LUT1]} and the data output_{[CB]};
connecting the clock input_{[Re3]} and the clock input_{[Re4]} to the clock input_{[CB]};
connecting the data input_{[Re3]} and the third data input_{[LUT1]} to the user enable_{[CB]};
connecting the data output_{[Re3]} to the fourth data input_{[LUT1]}; and
connecting the data output_{[LUT1]} to the data input_{[Re4]}.

10. The method in claim 1, wherein:
S2.1 further includes identifying on the sequential cell:
a data input;
a user-clock input;
a data output; and
an enable; and
S3.1.3 further includes:
configuring for the clock model_{[CB]} a data input_{[CB]}, a data output_{[CB]}, a user enable_{[CB]}, a clock input_{[CB]} and an enable_{[CB]};
configuring for the clock model_{[CB]} a clock detector_{[E2]}, a memory cell_{[ERe1]} and a multiplexer_{[MUX4]};
configuring for the clock detector_{[E2]} a user enable_{[E2]}, a clock input_{[E2]} and an active-edge output_{[E2]};
configuring for the memory cell_{[ERe1]} a clock input_{[ERe1]}, an enable_{[ERe1]}, a data input_{[ERe1]} and a data output_{[ERe1]};
configuring for the multiplexer_{[MUX4]} a first data input_{[MUX4]}, a second data input_{[MUX4]}, a signal selection_{[MUX4]} and a data output_{[MUX4]};
connecting the second data input_{[MUX4]} to the data input_{[CB]};
connecting the signal selection_{[MUX4]} to the enable_{[CB]};
connecting the data output_{[ERe1]} to the data output_{[CB]} and the first data input_{[MUX4]};
connecting the clock input_{[E2]} and the clock input_{[ERe1]} to the clock input_{[CB]};
connecting the user enable_{[E2]} to the user enable_{[CB]};
connecting the active-edge output_{[E2]} to the enable_{[ERe1]}; and
connecting the data output_{[MUX4]} to the data input_{[ERe1]}.

11. The method in claim 9, wherein the third state holder_{[Re3]} is configured to be a register or a latch.

12. The method in claim 9, wherein the fourth state holder_{[Re4]} is configured to be a register or a latch.

13. The method in claim 1, wherein the active edge is designated to be a rising edge or a falling edge.

14. The method in claim 1, wherein:
in S1, the plurality of sequential cells include:
a sequential cell_{[A1]}; and
a sequential cell_{[B1]};
in S2, on the directed graph:
the sequential cell_{[A1]} is converted to a node_{[A1]}; and
the sequential cell_{[B1]} is converted to a node_{[B1]};
in S3.1.1:
the node_{[A1]} is labeled as group A; and
the node_{[B1]} is labeled as group B;
in S3.1.2:
a clock model_{[CA1]} is inserted at the node_{[A1]}; and
the clock model_{[CA1]} is configured to include a data input_{[CA1]}, a data output_{[CA1]}, a user enable_{[CA1]} and a clock input_{[CA1]};
in S3.1.3:
a clock model_{[CB1]} is inserted at the node_{[B1]}; and
the clock model_{[CB1]} is configured to include a data input_{[CB1]}, a data output_{[CB1]}, a user enable_{[CB1]} and a clock input_{[CB1]};
S3.1 further includes:
configuring for the clock model_{[CA1]} a sampler_{[CA1s]};
configuring for the sampler_{[CA1s]} a data input_{[CA1s]}, an enable_{[CA1s]}, a clock input_{[CA1s]} and a data output_{[CA1s]};
configuring for the clock model_{[CB1]} a sampler_{[CB1s]};
configuring for the sampler_{[CB1s]} a data input_{[CB1s]}, an enable_{[CB1s]}, a clock input_{[CB1s]} and a data output_{[CB1s]};
identifying an anchor to which the user enable_{[CA1]} is connected; and
if the user enable_{[CB1]} is connected to the anchor:
configuring jointly for the clock model_{[CA1]} and for the clock model_{[CB1]} a clock detector_{[E12]};
configuring for the clock detector_{[E12]} a user enable_{[E12]}, a clock input_{[E12]} and an active-edge output_{[E12]};
connecting the user enable_{[E12]} to the anchor, the user enable_{[CA1]} and the user enable_{[CB1]};
connecting the clock input_{[E12]} to the clock input_{[CA1s]}, the clock input_{[CA1]}, the clock input_{[CB1s]} and the clock input_{[CB1]};
connecting the active-edge output_{[E12]} to the enable_{[CA1s]} and to the enable_{[CB1s]};
connecting the data input_{[CA1s]} to the data input_{[CA1]};
connecting the data output_{[CA1s]} to the data output_{[CA1]};
connecting the data input_{[CB1s]} to the data input_{[CB1]}; and
connecting the data output_{[CB1s]} to the data output_{[CB1]}.

15. The method in claim 1, wherein:
in S1, the plurality of sequential cells include:
a sequential cell_{[A1]}; and
a sequential cell_{[A2]};
in S2, on the directed graph:
the sequential cell_{[A1]} is converted to a node_{[A1]}; and
the sequential cell_{[A2]} is converted to a node_{[A2]};
in S3.1.1: the node_{[A1]} and the node_{[A2]} are both labeled as group A;
in S3.1.2:
a clock model_{[CA1]} is inserted at the node_{[A1]}; and
the clock model_{[CA1]} is configured to include a data input_{[CA1]}, a data output_{[CA1]}, a user enable_{[CA1]} and a clock input_{[CA1]};
a clock model_{[CA2]} is inserted at the node_{[A2]}; and
the clock model_{[CA2]} is configured to include a data input_{[CA2]}, a data output_{[CA2]}, a user enable_{[CA2]} and a clock input_{[CA2]};
S3.1 further includes:
configuring for the clock model_{[CA1]} a sampler_{[CA1s]};
configuring for the sampler_{[CAs1]} a data input_{[CA1s]}, an enable_{[CA1s]}, a clock input_{[CA1s]} and a data output_{[CA1s]};
configuring for the clock model_{[CA2]} a sampler_{[CA2s]};
configuring for the sampler_{[CA2s]} a data input_{[CA2s]}, an enable_{[CA2s]}, a clock input_{[CA2s]} and a data output_{[CA2s]};
identifying an anchor to which the user enable_{[CA1]} is connected; and
if the user enable_{[CA2]} is connected to the anchor:
configuring jointly for the clock model_{[CA1]} and for the clock model_{[CA2]} a clock detector_{[E12]};
configuring for the clock detector_{[E12]} a user enable_{[E12]}, a clock input_{[E12]} and an active-edge output_{[E12]};
connecting the user enable_{[E12]} to the anchor, the user enable_{[CA1]} and the user enable_{[CA2]};
connecting the clock input_{[E12]} to the clock input_{[CA1s]}, the clock input_{[CA1]}, the clock input_{[CA2s]} and the clock input_{[CA2]};
connecting the active-edge output_{[E12]} to the enable_{[CA1s]} and to the enable_{[CA2s]};
connecting the data input_{[CA1s]} to the data input_{[CA1]};
connecting the data output_{[CA1s]} to the data output_{[CA1]};
connecting the data input_{[CA2s]} to the data input_{[CA2]}; and
connecting the data output_{[CA2s]} to the data output_{[CA2]}.

16. The method in claim 1, wherein:
in S1, the plurality of sequential cells include:
a sequential cell_{[B1]}; and
a sequential cell_{[B2]};
in S2, on the directed graph:
the sequential cell_{[B1]} is converted to a node_{[B1]}; and
the sequential cell_{[B2]} is converted to a node_{[B2]};
in S3.1.1, the node_{[B1]} and the node_{[B2]} are both labeled as group B;
in S3.1.3:
a clock model_{[CB1]} is inserted at the node_{[B1]};
the clock model_{[CB1]} is configured to include a data input_{[CB1]}, a data output_{[CB1]}, a user enable_{[CB1]} and a clock input_{[CB1]};
a clock model_{[CB2]} is inserted at the node_{[B2]}; and
the clock model_{[CB2]} is configured to include a data input_{[CB2]}, a data output_{[CB2]}, a user enable_{[CB2]} and a clock input_{[CB2]};
S3.1 further includes:
configuring for the clock model_{[CB1]} a sampler_{[CB1s]};
configuring for the sampler_{[CB1s]} a data input_{[CB1s]}, an enable_{[CB1s]}, a clock input_{[CB1s]} and a data output_{[CB1s]};
configuring for the clock model_{[CB2s]} a sampler_{[CB2s]};
configuring for the sampler_{[CB2s]} a data input_{[CB2s]}, an enable_{[CB2s]}, a clock input_{[CB2s]} and a data output_{[CB2s]};
identifying an anchor to which the user enable_{[CB1]} is connected; and
if the user enable_{[CB2]} is connected to the anchor:
configuring jointly for the clock model_{[CB1]} and for the clock model_{[CB2]} a clock detector_{[E12]};
configuring for the clock detector_{[E12]} a user enable_{[E12]}, a clock input_{[E12]} and an active-edge output_{[E12]};
connecting the user enable_{[E12]} to the anchor, the user enable_{[CB1]} and the user enable_{[CB2]};
connecting the clock input_{[E12]} to the clock input_{[CB1s]}, the clock input_{[CB1]}, the clock input_{[CB2s]} and the clock input_{[CB2]};
connecting the active-edge output_{[E12]} to the enable_{[CB1s]} and to the enable_{[CB2s]};
connecting the data input_{[CB1s]} to the data input_{[CB1]};
connecting the data output_{[CB1s]} to the data output_{[CB1]};
connecting the data input_{[CB2s]} to the data input_{[CB2]}; and
connecting the data output_{[CB2s]} to the data output_{[CB2]}.

17. The method in claim 1, further comprising the steps of:
S4) converting the IC design into a modified design;
S5) implementing the modified design on the FPGA; and
S6) validating the IC design with the FPGA on which the modified design is implemented.

18. A method for emulating an IC design with an FPGA, comprising the steps of:
S1) identifying in the IC design:
a primary clock;
a subcircuit;
a plurality of generated clocks, which are derived from the primary clock after being processed by the subcircuit; and
a plurality of sequential cells, wherein a user clock being connected to one of the plurality of sequential cells is the primary clock or one of the plurality of generated clocks;
S2) converting the IC design to a directed graph, including:
2.1) converting the plurality of sequential cells to a plurality of nodes, including:
2.1.1) converting a sequential cell in the plurality of sequential cells to a node, including:
i) identifying on the sequential cell:
a user clock by which the sequential cell is driven;
a data input;
a user-clock input to which the user clock is connected; and
a data output; and
ii) converting the sequential cell to a node, including:
defining a logic path having a pair of endpoints, wherein: the user-clock input constitutes one of the pair of endpoints; and the data output constitutes the other one of the pair of endpoints;
defining a node on the logic path between the pair of endpoints; and
defining an other logic path and defining a node on the other logic path between its pair of endpoints; and
2.1.2) converting the rest of the plurality of sequential cells to nodes; and
2.2) constructing the directed graph by connecting the plurality of nodes; and
S3) configuring the plurality of nodes on the directed graph which includes exactly one root node and a plurality of leaf nodes, including:
3.1) inserting a clock model_{[CA]} at a node on the directed graph, including:
3.1.1) labeling all nodes on the directed graph as group A;
3.1.2) modifying the nodes that are labeled as group A, including:
i) configuring the clock model_{[CA]}, which includes a data input_{[CA]}, a data output_{[CA]}, a user enable_{[CA]} and a clock input_{[CA]};
ii) modifying a node_{[A]} in the plurality of nodes being labeled as group A, including:
ii.1) identifying a logic path by which the node_{[A]} is defined in view of S2, wherein:
an endpoint of the logic path is located at a user-clock input_{[A]};
the other endpoint of the logic path is located at a data output_{[A]}; and
a user clock_{[A]} is connected to the user-clock input_{[A]};
ii.2) inserting the clock model_{[CA]} at the node_{[A]}, including:
connecting the data input_{[CA]} to what was connected to the data input_{[A]};
connecting the data output_{[CA]} to what was connected to the data output_{[A]};
connecting the user enable_{[CA]} to what was connected to the user-clock input_{[A]}; and
connecting the clock input_{[CA]} to a primary clock′ which is equal to or greater than the primary clock in frequencies; and
ii.3) configuring the clock model_{[CA]}, including:
sampling a signal from the data input_{[CA]} at an active edge of the primary clock′ to obtain a data sample for a period of the primary clock′ led by the active edge;
when an N-th active edge is occurring on the user clock_{[A]}:
obtaining a data sample_{[N]} for a contemporary period of the primary clock′; and
outputting to the data output_{[CA]} the data sample_{[N]} until an N+1-th active edge occurs on the user clock_{[A]}; and
when the N+1-th active edge is occurring on the user clock_{[A]}:
obtaining a data sample_{[N+1]} for a contemporary period of the primary clock′; and
outputting to the data output_{[CA]} the data sample_{[N+1]} until an N+2-th active edge occurs on the user clock_{[A]}; and
iii) modifying the rest of nodes_{[A]} in the plurality of nodes being labeled as group A; and
3.2) configuring a phase shift for the primary clock′, including:
3.2.1) identifying a path on the directed graph and configuring a phase shift for the primary clock′ to which a node on the path is connected;
3.2.2) numbering on the path a total of K nodes, which includes:
a node_{[#1]}, which is the root node;
a node_{[#H]};
a node_{[#U]}; and
a node_{[#K]}, which is one of the leaf nodes, wherein:
$$1 \leq H \leq U \leq K ;$$
3.2.3) letting F(x−t_{U})=F(x−t_{H}), wherein:
t_{U}≥t_{H};
F(x−t_{U}) represents a waveform of the primary clock′ to which the node_{[#U]} is connected;
t_{U} indicates the waveform's phase;
F(x−t_{H}) represents a waveform of the primary clock′ to which the node_{[#H]} is connected; and
t_{U} indicates the waveform's phase; and
3.2.4) identifying an other path on the directed graph and configuring a phase shift for the primary clock′ to which a node on the other path is connected.

19. The method in claim 18, wherein S3.1 further includes:
configuring for the clock model_{[CA]} a clock detector_{[E1]} and a sampler_{[CAs]};
configuring for the clock detector_{[E1]} a user enable_{[E1]}, a clock input_{[E1]} and an active-edge output_{[E1]};
configuring for the sampler_{[CAs]} a data input_{[CAs]}, an enable_{[CAs]}, a clock input_{[CAs]} and a data output_{[CAs]};
connecting the user enable_{[E1]} to the user enable_{[CA]};
connecting the clock input_{[E1]} and the clock input_{[CAs]} to the clock input_{[CA]};
connecting the active-edge output_{[E1]} to the enable_{[CAs]};
connecting the data input_{[CAs]} to the data input_{[CA]}; and
connecting the data output_{[CAs]} to the data output_{[CA]}.

20. The method in claim 19, wherein S3.1 further includes:
converting for the sampler_{[CAs]} a first state holder_{[Re1]}, a second state holder_{[Re2]} and a multiplexer_{[MUX1]};
configuring for the first state holder_{[Re1]} a clock input_{[Re1]}, a data input_{[Re1]} and a data output_{[Re1]};
configuring for the second state holder_{[Re2]} a clock input_{[Re2]}, a data input_{[Re2]} and a data output_{[Re2]};
configuring for the multiplexer_{[MUX1]} a first data input_{[MUX1]}, a second data input_{[MUX1]}, a signal selection_{[MUX1]} and a data output_{[MUX1]};
connecting the data input_{[Re1]} to the data input_{[CAs]};
connecting the data output_{[MUX1]} to the data output_{[CAs]};
connecting the clock input_{[Re1]} and the clock input_{[Re2]} to the clock input_{[CAs]};
connecting the data output_{[Re1]} to the first data input_{[MUX1]};
connecting the data input_{[Re2]} to the data output_{[MUX1]};
connecting the data output_{[Re2]} to the second data input_{[MUX1]}; and
connecting the enable_{[CAs]} to the signal selection_{[MUX1]}.

21. The method in claim 18, wherein:
in S1, the plurality of sequential cells include:
a sequential cell_{[A1]}; and
a sequential cell_{[A2]};
in S2, on the directed graph:
the sequential cell_{[A1]} is converted to a node_{[A1]}; and
the sequential cell_{[A2]} is converted to a node_{[A2]};
in S3.1.1: the node_{[A1]} and the node_{[A2]} are both labeled as group A;
in S3.1.2:
a clock model_{[CA1]} is inserted at the node_{[A1]}; and
the clock model_{[CA1]} is configured to include a data input_{[CA1]}, a data output_{[CA1]}, a user enable_{[CA1]} and a clock input_{[CA1]};
s clock model_{[CA2]} is inserted at the node_{[A2]}; and
the clock model_{[CA2]} is configured to include a data input_{[CA2]}, a data output_{[CA2]}, a user enable_{[CA2]} and a clock input_{[CA2]};
S3.1 further includes:
configuring for the clock model_{[CA1]} a sampler_{[CA1s]};
configuring for the sampler_{[CAs1]} a data input_{[CA1s]}, an enable_{[CA1s]}, a clock input_{[CA1s]} and a data output_{[CA1s]};
configuring for the clock model_{[CA2]} a sampler_{[CA2s]};
configuring for the sampler_{[CA2s]} a data input_{[CA2s]}, an enable_{[CA2s]}, a clock input_{[CA2s]} and a data output_{[CA2s]};
identifying an anchor to which the user enable_{[CA1]} is connected; and
if the user enable_{[CA2]} is connected to the anchor:
configuring jointly for the clock model_{[CA1]} and for the clock model_{[CA2]} a clock detector_{[E12]};
configuring for the clock detector_{[E12]} a user enable_{[E12]}, a clock input_{[E12]} and an active-edge output_{[E12]};
connecting the user enable_{[E12]} to the anchor, the user enable_{[CA1]} and the user enable_{[CA2]};
connecting the clock input_{[E12]} to the clock input_{[CA1s]}, the clock input_{[CA1]}, the clock input_{[CA2s]} and the clock input_{[CA2]};
connecting the active-edge output_{[E12]} to the enable_{[CA1s]} and to the enable_{[CA2s]};
connecting the data input_{[CA1s]} to the data input_{[CA1]};
connecting the data output_{[CA1s]} to the data output_{[CA1]};
connecting the data input_{[CA2s]} to the data input_{[CA2]}; and
connecting the data output_{[CA2s]} to the data output_{[CA2]}.

22. A method for emulating an IC design with an FPGA, comprising the steps of:
S1) identifying in the IC design:
a primary clock;
a subcircuit;
a plurality of generated clocks, which are derived from the primary clock after being processed by the subcircuit; and
a plurality of sequential cells, wherein a user clock being connected to one of the plurality of sequential cells is the primary clock or one of the plurality of generated clocks;
S2) converting the IC design to a directed graph, including:
2.1) converting the plurality of sequential cells to a plurality of nodes, including:
2.1.1) converting a sequential cell in the plurality of sequential cells to a node, including:
i) identifying on the sequential cell:
a user clock by which the sequential cell is driven;
a data input;
a user-clock input to which the user clock is connected; and
a data output; and
ii) converting the sequential cell to a node, including:
defining a logic path having a pair of endpoints, wherein: the user-clock input constitutes one of the pair of endpoints; and the data output constitutes the other one of the pair of endpoints;
defining a node on the logic path between the pair of endpoints; and
defining an other logic path and defining a node on the other logic path between its pair of endpoints; and
2.1.2) converting the rest of the plurality of sequential to nodes; and
2.2) constructing the directed graph by connecting the plurality of nodes; and
S3) configuring the plurality of nodes on the directed graph which includes exactly one root node and a plurality of leaf nodes, including:
3.1) inserting a clock model_{[CB]} at a node on the directed graph, including:
3.1.1) labeling all nodes on the directed graph as group B;
3.1.2) modifying the nodes that are labeled as group B, including:
i) configuring the clock model_{[CB]}, which includes a data input_{[CB]}, a data output_{[CB]}, a user enable_{[CB]} and a clock input_{[CB]};
ii) modifying a node_{[B]} in the plurality of nodes being labeled as group B, including:
ii.1) identifying a logic path by which the node_{[B]} is defined in view of S2, wherein:
an endpoint of the logic path is located at a user-clock input_{[B]};
the other endpoint of the logic path is located at a data output_{[B]}; and
a user clock_{[B]} is connected to the user-clock input_{[B]};
ii.2) inserting the clock model_{[CB]} at the node_{[B]}, including:
connecting the data input_{[CB]} to what was connected to the data input_{[B]};
connecting the data output_{[CB]} to what was connected to the data output_{[B]};
connecting the user enable_{[CB]} to what was connected to the user-clock input_{[B]}; and
connecting the clock input_{[CB]} to a primary clock′ which is equal to or greater than the primary clock in frequencies; and
ii.3) configuring the clock model_{[CB]}, including:
when an active edge is occurring on the user clock_{[B]} and when an active edge is occurring on the primary clock′:
sampling a signal from the data input_{[CB]} to obtain a data sample for a period of the primary clock′ led by the active edge; and
outputting the data sample to the data output_{[CB]}; and
when no active edge occurs on the user clock_{[B]} or no active edge occurs on the primary clock′:
sampling nothing from the data input_{[CB]}; and
outputting nothing to the data output_{[CB]}; and
iii) modifying the rest of nodes_{[B]} in the plurality of nodes being labeled as group B; and
3.2) configuring a phase shift for the primary clock′, including:
3.2.1) identifying a path on the directed graph and configuring a phase shift for the primary clock′ to which a node on the path is connected;
3.2.2) numbering on the path a total of K nodes, which includes:
a node_{[#1]}, which is the root node;
a node_{[#N]};
a node_{[#M]}; and
a node_{[#K]}, which is one of the leaf nodes, wherein:
$$1 \leq N \leq M \leq K ;$$
3.2.3) letting F(x−t_{M})=F(x−t_{N}), wherein:
t_{M}>t_{N};
F(x−t_{M}) represents a waveform of the primary clock′ to which the node_{[#M]} is connected;
t_{M} indicates the waveform's phase;
F(x−t_{N}) represents a waveform of the primary clock′ to which the node_{[#N]} is connected; and
t_{N} indicates the waveform's phase; and
3.2.4) identifying an other path on the directed graph and configuring a phase shift for the primary clock′ to which a node on the other path is connected.

23. The method in claim 22, wherein S3.1 further includes:
configuring for the clock model_{[CB]} a clock detector_{[E2]} and a sampler_{[CBs]};
configuring for the clock detector_{[E2]} a user enable_{[E2]}, a clock input_{[E2]} and an active-edge output_{[E2]};
configuring for the sampler_{[CBs]} a clock input_{[CBs]}, an enable_{[CBs]}, a data input_{[CBs]} and a data output_{[CBs]};
connecting the data input_{[CBs]} to the data input_{[CB]};
connecting the data output_{[CBs]} to the data output_{[CB]};
connecting the clock input_{[E2]} and the clock input_{[CBs]} to the clock input_{[CB]};
connecting the user enable_{[E2]} to the user enable_{[CB]}; and
connecting the active-edge output_{[E2]} to the enable_{[CBs]}.

24. The method in claim 23, wherein the sampler_{[CBs]} is configured to be a register having an enable.

25. The method in claim 23, wherein:
in S1, the plurality of sequential cells include:
a sequential cell_{[B1]}; and
a sequential cell_{[B2]};
in S2, on the directed graph:
the sequential cell_{[B1]} is converted to a node_{[B1]}; and
the sequential cell_{[B2]} is converted to a node_{[B2]};
in S3.1.1: the node_{[B1]} and the node_{[B2]} are both labeled as group B;
in S3.1.2:
a clock model_{[CB1]} is inserted at the node_{[B1]};
the clock model_{[CB1]} is configured to include a data input_{[CB1]}, a data output_{[CB1]}, a user enable_{[CB1]} and a clock input_{[CB1]};
a clock model_{[CB2]} is inserted at the node_{[B2]}; and
the clock model_{[CB2]} is configured to include a data input_{[CB2]}, a data output_{[CB2]}, a user enable_{[CB2]} and a clock input_{[CB2]};
S3.1 further includes:
configuring for the clock model_{[CB1]} a sampler_{[CB1s]};
configuring for the sampler_{[CB1s]} a data input_{[CB1s]}, an enable_{[CB1s]}, a clock input_{[CB1s]} and a data output_{[CB1s]};
configuring for the clock model_{[CB2s]} a sampler_{[CB2s]};
configuring for the sampler_{[CB2s]} a data input_{[CB2s]}, an enable_{[CB2s]}, a clock input_{[CB2s]} and a data output_{[CB2s]};
identifying an anchor to which the user enable_{[CB1]} is connected; and
if the user enable_{[CB2]} is connected to the anchor:
configuring jointly for the clock model_{[CB1]} and for the clock model_{[CB2]} a clock detector_{[E12]};
configuring for the clock detector_{[E12]} a user enable_{[E12]}, a clock input_{[E12]} and an active-edge output_{[E12]};
connecting the user enable_{[E12]} to the anchor, the user enable_{[CB1]} and the user enable_{[CB2]};
connecting the clock input_{[E12]} to the clock input_{[CB1s]}, the clock input_{[CB1]}, the clock input_{[CB2s]} and the clock input_{[CB2]};
connecting the active-edge output_{[E12]} to the enable_{[CB1s]} and to the enable_{[CB2s]};
connecting the data input_{[CB1s]} to the data input_{[CB1]};
connecting the data output_{[CB1s]} to the data output_{[CB1]};
connecting the data input_{[CB2s]} to the data input_{[CB2]}; and
connecting the data output_{[CB2s]} to the data output_{[CB2]}.

26. A system for emulating an IC design with an FPGA, comprising a processor and a computer-readable storage medium in communication with the processor, wherein: the system implements the method in claim 1 when the processor executes a program in the computer-readable storage medium.

27. A non-transitory computer-readable storage medium in which at least one instruction or at least one program is stored, wherein: the at least one instruction or the at least one program is loadable and executable by a processor to implement the method in claim 1.
